(19) United States
(12) Patent Application Publication
(10) Pub. No.: US 2002/0078255 A1
(43) Pub. Date: Jun. 20, 2002

(54) Pluggable instantiable distributed objects

(76) Inventor: Shankar Narayan, Sunnyvale, CA (US)

Correspondence Address: HICKMAN PALERMO TRUONG & BECKER, LLP, 1600 WILLOW STREET, SAN JOSE, CA, 95125, US

(21) Appl. No.: 09/978,867

(22) Filed: Oct. 16, 2001

Related U.S. Application Data
(60) Provisional application No. 60/241,447, filed on Oct. 17, 2000.
(60) Provisional application No. 60/241,273, filed on Oct. 17, 2000.

(51) Int. Cl. G06F 9/46; G06F 9/00

(52) U.S. Cl. 709/316; 709/330

(57) ABSTRACT

A model is provided for building powerful re-usable distributed components. The model is based on instantiable distributed objects (IDOs). IDOs are distributed objects that are instantiated in response to a request from a client to instantiate the IDOs. Typically, the request is transmitted by a client over a network to another computer. Once instantiated, an IDO may not only be addressed by the client that requested the instantiation, but by other clients, who may also interact with the IDO by issuing requests addressed to it. IDOs may be organized into hierarchies of objects that have a hierarchical relationship based on containment. Containment rules govern how a parent object in the hierarchy may contain child objects in the hierarchy. For example, an object may only be contained by the object that instantiated it. As a consequence, two child objects of a parent object interact with each other through their parent.

### RELATED APPLICATIONS

This application claims priority to U.S. Provisional Patent Application No. 60/241,447, entitled “Internet Widgets and an Architecture to Create Integrated Service Ecosystems Using Internet Widgets”, filed by Shankar Narayan on Oct. 17, 2000, the contents of which are incorporated by reference as originally set forth herein.

This application claims priority to U.S. Provisional Patent Application No. 60/241,273, entitled “Question Associated Information Storage and Retrieval Architecture Using Internet Gidgets”, filed by Shankar Narayan on Oct. 17, 2000, the contents of which are incorporated by reference in its entirety.

This application is related to the U.S. patent application entitled “Question Associated Information Storage and Retrieval Architecture Using Internet Gidgets”, attorney docket number 60033-0017, filed on the equal day herewith by Shankar Narayan, the contents of which are herein incorporated by reference in its entirety.

This application is related to the U.S. patent application entitled “Synchronized Computing With Internet Widgets”, attorney docket number 60033-0011, filed on the equal day herewith by Shankar Narayan, the contents of which are herein incorporated by reference in its entirety.

### FIELD OF THE INVENTION

The present invention relates to distributed objects, and in particular, facilitating the development of application components that may be easily transported over a network and integrated into applications as distributable objects.

### BACKGROUND OF THE INVENTION

Software engineering has defined several abstractions of software modules that help in the creation of software solutions. The software module abstractions enable creators of software to use pre-built software modules constructed as specified by the definition of a software module abstraction to create solutions with the functionality that is implemented in these modules. A brief enumeration of such abstractions that have been specified in software literature and are in vogue in the industry include, archived libraries that provide application programmer interfaces (APIs), shared libraries, object oriented class libraries, and software components such as java beans or COM [MICR95] (Component Object Model, activeX) controls, DOM [W3C98] (document object model), MVC [STEV87] (Model viewer controller abstraction). There exists a copious amount of literature discussing the benefits of creating such modules, and using them in software construction or composition. While the above described software module abstractions solve some very important problems, there are some limitations in current technology options for meaningful integration of services using client/server architectures.

For example, due to the historical evolution of these definitions, they attempt to define a software module abstraction that benefits the design of software that primarily falls into one of the following categories: (1) a single system software solution, (2) a software solution that has predominantly graphical user interface functionality (GUI), or (3) a solution that is tailored to simplify integrating software modules that provide distributed computing functionality. Because these software module abstractions are intended to benefit design of software that falls primarily into one of these categories, it is difficult to use these software module abstractions to create software solutions is optimized for each of the categories of software enumerated above. Therefore there is a need to define a software module in such a way that users of these modules do not have to compensate for the missing elements of conventional software module abstractions by doing additional software creation work, as well as a need to spend less effort in composing a software solution than using any of the above described software module abstractions.

### SUMMARY OF THE INVENTION

Techniques are provided for building powerful re-usable distributed components. The model is based on instantiable distributed objects (IDOs). According to an aspect of the present invention, an IDO is a distributed object that is instantiated in response to a request from a client to instantiate the IDO. Typically, the request is transmitted by a client over a network to another computer. Once instantiated, the IDO may not only be addressed by the client that requested the instantiation, but by other clients, who may also interact with the IDO by issuing requests addressed to it. Also described is an infrastructure for instantiating IDOs, persistently storing IDOs, and designs for interfaces that an IDO should support.

According to another aspect of the present invention, IDOs may be organized into hierarchies of objects that have a hierarchical relationship based on containment. The model prescribes containment rules governing how a parent object in the hierarchy may contain one or more child objects in the hierarchy. For example, an object may only be contained by the object that instantiated it. As a consequence, two child objects of a parent object interact with each other through their parent.

An object hierarchy that is based on containment relationships that conform to the containment rules is referred to as a plane of execution. A primary object hierarchy is configured to create another object hierarchy that mirrors the containment relationship of the primary object hierarchy. Each object in the other object hierarchy (1) is an instantiable distributed object that corresponds to a “primary” object in the primary object hierarchy and (2) is instantiated by the corresponding primary object.

Typically, the primary object hierarchy model is composed of primary/model objects that model some entity, while the secondary objects are composed of secondary/visualization objects that define a visual view of the modeled entity. For example, a primary/object model may be statistical data about a country's population; a secondary/visualization reflection object may be an object defining a pie chart or bar graph view of the statistical data, or a graphical user component for editing the statistical data. The reflection objects may be integrated into one or more application user interfaces. The model empowers developers of services to not only develop server side software for the services, but user interfaces that can be incorporated into applications as pluggable components.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a flowchart depicting the steps of a process for instantiating an instantiable distributed object according to an embodiment of the present invention;

FIG. 1B is a flowchart depicting the steps of a process for instantiating an instantiable distributed object according to an embodiment of the present invention;

FIG. 2A is a containment hierarchy graph used to illustrate a containment relationship;

FIG. 2B is a containment hierarchy graph used to illustrate a containment relationship;

FIG. 3A is a containment hierarchy graph that illustrates a containment relationship among unlayered objects;

FIG. 3B is a containment hierarchy graph that illustrates a containment relationship among layered objects;

FIG. 4A is a containment hierarchy graph that illustrates a containment relationship among layered objects;

FIG. 4B is a containment hierarchy graph that illustrates a containment relationship among unlayered objects;

FIG. 4C is a containment hierarchy graph that illustrates a containment relationship among layered objects;

FIG. 5A is a diagram illustrating a plane of execution according to an embodiment of the present invention;

FIG. 5B is a diagram illustrating a parallel plane of execution according to an embodiment of the present;

FIG. 5C is a diagram illustrating parallel planes of execution that include a model/primary plane of execution and a visualization plane of execution according to an embodiment of the present invention;

FIG. 6A is a diagram illustrating a process for creating an internet widget and the containment relationship that exists between objects at a particular stage of the process;

FIG. 6B is a diagram illustrating a process for creating an internet widget and the containment relationship that exists between objects at a particular stage of the process;

FIG. 6C is a diagram illustrating a process for creating an internet widget and the containment relationship that exists between objects at a particular stage of the process;

FIG. 7 is a block diagram depicting a distributed object partitioned into an instantiable virtual distributed object and an instantiable physical distributed object that manages concurrent access to a device or data requiring consistent access;

FIG. 8 is a block diagram depicting an illustration of virtual service internet widgets according to an embodiment of the present invention; and

FIG. 9 is a block diagram depicting a computer system upon which an embodiment of the present invention may be implemented.

### DETAILED DESCRIPTION OF THE INVENTION

A method and apparatus for implementing distributable objects is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Described herein is a model for building powerful re-usable distributed components. The model is based on instantiable distributed objects (IDOs). An IDO is a distributed object that is instantiated in response to a request from a client to instantiate the IDO. Typically, the request is transmitted by a client over a network to another computer. Once instantiated, the IDO may not only be addressed by the client that requested the instantiation, but by other clients, who may also interact with the IDO by issuing requests addressed to it. In conventional distributed systems, distributed objects that provide services that may be accessed over a network by clients are not launched by the clients themselves. Rather, the distributed objects are launched by some other means. For example, a distributed object may be conventionally launched by a server in response to commands received from administrators who manage computers on which the server resides. Also described is an infrastructure for instantiating IDOs, persistently storing IDOs, and designs for interfaces that an IDO should support.

The model also defines internet widgets as a pair of IDOs—one being a primary/model object that models some entity, the other being a secondary/visualization reflection object defining a visual view of the modeled entity. For example, a primary/object model may be statistical data about a country's population; a secondary/visualization reflection object may be an object defining a pie chart or bar graph view of the statistical data, or a graphical user component for editing the statistical data. The reflection objects may be integrated into one or more application user interfaces. The model empowers developers of services to not only develop server side software for the services, but user interfaces that can be incorporated into applications as pluggable components.

The internet widgets may be organized into hierarchies of objects that have a hierarchical relationship based on containment. The model prescribes containment rules governing how a parent object in the hierarchy may contain one or more child objects in the hierarchy. For example, an object may only be contained by the object that instantiated it. As a consequence, two child objects of a parent object interact with each other through their parent.

An object hierarchy that is based on containment relationships that conform to the containment rules is referred to as a plane of execution. A primary object hierarchy is configured to create another object hierarchy that mirrors the containment relationship of the primary object hierarchy. Each object in the other object hierarchy (1) is an instantiable distributed object that corresponds to a “primary” object in the primary object hierarchy and (2) is instantiated by the corresponding primary object. Typically, the primary object hierarchy model is composed of primary/model objects while the secondary objects are composed of secondary/visualization objects.

The Sections I, II, and III of the specification describe software paradigms and issues related to the design of internet issues. Section IV describes internet widgets and concepts particularly germane to internet widgets. Section V describes some of advantages of internet widgets. Section VI is a list of references cited by the application. Section VII is a hardware definition section describing a computer system which may be used to implement an embodiment of the present invention.

I Historically Significant Software Development Paradigms and Software Module Abstractions that Lead up to Internet Widgets:

In the last two decades, some major paradigms of computing have shaped how software is designed. One of these idioms is distributed computing. Another powerful software design paradigm that influenced how software is developed is object (component) oriented programming. The third software engineering methodology that impacted software design is the design approach to human computer interface also known as user interface, both in graphical user interfaces and non graphical user interfaces. The historical evolution of these paradigms is described briefly below.

Distributed Computing:

In evolutionary sense, the initial network oriented software application were the ground breaking distributed computing applications. Various networking technologies that comprised of different network kinds of network hardware in conjunction with data transfer protocols formed the basis for network applications. Through a process of standardization there are fewer protocols, some of the popular ones being TCP/IP, OSI X.25, SNA, IPX etc. The software applications that were to communicate with each other over the network used these protocols. Utility software libraries and software abstractions were built over these protocols to simplify the development of networked software. BSD Socket based libraries were some of the early utility layers that help reduce the programming effort in writing networked software. An architectural model that described the common elements in network programming, known as client/server architecture was an influential design consideration in software development. To minimize the need for software developers to comprehend the network internals to develop networked applications, the distributed computing designed remote procedure calls (RPCs—ONC, DCE) to enable software developers to ignore the networked location of useful functionality at different locations and treat this functionality similar to the functionality that is available on a local computer as a library. This was popular prior to the emergence of object oriented technology. With the advent of object oriented technologies, the distributed computing community transformed the utility functionality that simplified network programming into well encapsulated classes to create distributed object technologies. Some of the popular industrial technologies in vogue are CORBA [OMG97], DCOM, RMI, EJB [VLAM99] etc. In all of these technologies, the client/server abstraction forms the basis. They all have a server/service module/object that implements the useful functionality, and a client module that invokes this useful functionality with minimal software needed for network related programming, (i.e establish connections, pass messages and data between network location etc). In RPCs, the interface that is used to communicate between the clients and servers is procedural, and in distributed object technologies the interfaces are object oriented. The client programs invoke the interfaces procedurally, or through references of objects to benefit from the pre-built functionality implemented by the servers.

Component (Object) Oriented Programming:

Enormous amount of academic and trade literature exists documenting the benefits of object oriented programming and component oriented programming. Most significant benefit from this model of programming is the ability to construct highly re-usable components that can be used in the software creation. Visual programming components such as menu buttons, forms etc help in integrating useful functionality with these components. Typically, the user interactions that drive the visual programming elements to do some useful work is bound by the programmer to some meaningful functionality. In this type of programming, the programmer does not have to write the code that implements the visual elements and use pre-fabricated components. Another area where component oriented programming is gaining popularity in is the area of enterprise applications (refer to enterprise java beans), where the business logic of a program is implemented as a re-usable component that can be used in any container. In this mode of programming the container manages various aspects of the component, to minimize the coding effort needed to create a component. Based on the EJB specification (V 2.0) [what is EJB] enterprise components are typically server side functionality made available as an object for usage by networked clients. The client side program that utilizes the server component functionality does not have to implement the code for the server component. The above examples show the benefit of creating server side components (ejbs) and client side components (activeX controls and java beans). An Internet widget, as shall be explained in greater detail, may create a component that contains both server (business logic) and client side (visual elements) elements. There are some significant benefits to software creation that may be realized by including both elements in a single component.

Human Computer Interface:

Human computer interface as a software discipline has grown enormously from the days when batch cards were used to interact with the software applications. In the days of dumb terminals, most software applications provided a command line interface. This interface enabled the users to interact with software applications from their terminals in real time. Besides enabling the interaction with the software in real time, the command line interface also facilitated batch mode usage of software. This aspect of command line invocation made it possible for people to create a workflow based on useful functionality implemented by useful programs. Ever since graphical workstations became technologically viable, the emphasis of the human computer interface has largely been on designing intuitive graphical user interfaces that will help the users of computers. Due to some poor design, this advancement in the ease of use at times has come at the expense of not providing a batch mode invocation of the software designed with GUI. The middleware that helps in building of graphical user interface elements in software (such as X-Windows, Java Swing, MFC) etc pay scant attention to the ability to create a custom workflow using software applications and iterate over such workflows with no human intervention to improve automation. Internet-widgets by design attempts to address this as will be described in this section.

With the advent of the world wide web, and HTML based composition of useful information that a user can interact with, the invocation of software functionality and the appearance of the presentation that the user interacts with has dramatically changed. In traditional software applications, various visual elements such as toolbars, menus, and dialogs provided the visual cues to connote the nature of the functionality bound to these elements. Any assistance to a new user about the functionality behind the GUI elements has been sparse and continues to be sparse in applications that are designed with the old GUI design methodology. In the web world, large amount of textual and image information is used to aid the user of a software to invoke some useful software functionality. As GUI applications are designed with a very tightly integrated visual elements, it is non-trivial to add associated visual aids such as images to help in the usability of applications. To regular users of software applications, providing large amount of textual and image help will not be of great value, and could be a hindrance if adding the contextual assistance needs the user to perform more user interface actions to perform the same software task. One of the usability measures that govern the design of software is to determine how many actions are needed by the user to perform the necessary software task. This has to be traded off with the other usability goal of providing contextual help that helps the user understand the implied functionality behind the visual interface elements. Typically, the power users will find excessive help less useful in comparison with novice users. Considering the needs of these users are different, one is better served with an ability to customize the UI based on the skill level of the user. The traditional GUI applications provide little opportunity to add contextual visual help beyond what is already designed by the application developer. The HTML based UI makes it difficult to create the rich feature set that typically is created using GUI middleware components (designing a word processor using HTML is more difficult in comparison to using GUI middleware such MFC/Motif/Java (swing) etc). The internet-widget abstraction described herein makes it possible for tailoring the presentation differently for different types of users using the same application and its functionality thus making it the best of the two worlds of user interface design.

Model Viewer Controller:

A significant development in the user interface design has been the model, viewer, controller (MVC) abstraction. The reader is referred to abundant literature that exists on this design principle.

II Properties of Software Modules Relevant to the Design of Internet Widgets:

This section describes several important features of familiar concepts that will help in understanding and analyzing the usefulness of internet widgets. Initially, some preliminary terminology is defined. Next, various categories of distributed applications are described and rudimentary but relevant concepts are recapitulated. Finally, the section describes a way graphical user interfaces are used in distributed computing.

Definitions:

Definition of a Service:

The services described herein are software services, some times also known as electronic services or e-services. In the abstract, any electronic service is made up of the following components:

1. clients with or without a user interface that the user interacts with (typically a GUI or a command line interface),

2. network connectivity software that connects the user with the software that provides the actual service (typically distributed object middleware), and

3. and one or more server applications (the actual business or useful code).

In current day middleware solutions that facilitate the creation of electronic services, the electronic service implements one are more interfaces (as in rmi, corba, ejb, or e-speak) using an interface definition language (IDL). These interfaces are made available for client usage, which the clients can find through various brokering/discovery mechanisms. Some additional convenience wrapper code snippets generated from the definition of the interface make it easy for the clients of these services to invoke the methods in the interface that are bound to useful service functionality. It is the responsibility of the user/client of the service to create a user interface program that ties in the client with the interface of the server in a meaningful fashion. Typically some self contained client application is provided by the server software vendor. It is quite conceivable to have several versions of clients for the same server interface.

A Formal Representation of a Service is:

Let a service be represented by an ordered pair of a server set and a UI client set pair sc={{s},{uc}} where s is a server and uc is any user interface client of the server where UI client and server are as defined below. The UI client has a user interface component that is either graphical or command line.

Server Application:

A server application is that application that enables other applications to execute the some functionality, and it is accessible over a network.

UI Client Application:

A UI client application is that application that a user interacts with, the application in turn uses the server functionality of other servers.

A UI client application is distinguished from any other client application in the definition of a service. Any client need not have a user interface, unlike a UI client application. In every service there is an expectation that there is at least one user interface client.

A service is also distinguished from a server. A single server can have several UI clients, and a UI client can utilize functionality from several servers.

It is significant to describe the relationship between any particular UI client and a specific set of servers as a service as will become apparent in the discussion about internet widgets.

A UI client application ‘uc’ that uses networked functionality from several servers ‘s1’, ‘s2’, and ‘s3’ can be described as service {{s1,s2,s3}, {uc}}.

Note: It should be noted that a single server in the {{s},{uc}} ordered pair will not be exclusively bound to a single UI client uc. For purposes of illustration, it is assumed that a service has only one UI client application. As it will become apparent, constraining the service to be bound to a single UI client application is done only to simplify the discussion, and this causes no loss of generality.

Software Applications Operating on Data:

Anyone that has ever used a software application knows that almost all software applications operate on some data. The data that a software module operates on can be classified into two types—raw (input) data and processed data—defined as follows. Raw (Input) data: Raw (Input) data also called the input data is that data that is provided to a software application for the software application to process during an execution run of the application.

Processed data: Processed data is the data that software applications create internally using the raw (input) data during the execution run of the application. Processed data can have a transient life span if it is not committed to some storage as Processed (output) data.

The raw (input) data can be supplied to an application in various forms at various stages in an applications execution run. Some of the common ways the raw (input) data is supplied to software applications are:

1. command line data,

2. data file/network/service/device streams

a. application data that is operated on to perform useful functions

b. model data for viewable objects

c. configuration data such as localization, customization etc.,

3. data base streams, and

4. User interface interaction that creates raw data that is used in computing processed data.

Raw data is input data to software applications. This raw data can be input to an application at any point in the execution lifetime of the application. Processed data is computed using raw data and software code. Processed data can be transient for the duration of the application, or can become persistent by committing the processed data to some storage medium. This is true for even the processed data representing graphical or audio like processed data that is visualized or sonified.

The discussion on raw data(input data) and processed data is presented in order to help analyze how internet widgets process various types of raw data and the processed data. For the internet widget abstraction to be used as a model for creating software modules, it need not diminish the ability of application developers to use the raw data and processed data in modes that are familiar to software developers.

The applications typically have a mechanism to read the raw (input) data and create internal representations of this data. In legacy applications, the data is represented in an unstructured form, and each application had a peculiar syntactical representation and semantic association of input data depending on the source (be it file streams, command line arguments, data bases etc.) With the advent of serialization, the same data structures used in representing abstract data in programs are used to represent the structure of the raw data. While command line, and UI data are translated into data structures still, raw data read from other streams is used to initialize program data structures using the serialization constructs available in some programming languages. Similarly, the output data is also stored using serialization.

Classification of Distributed Applications:

This subsection describes classifications of distributed applications based on the way client server applications are some times used in practice.

Single Server/Single UI Client Applications (SSSC) & Non-client Server Applications:

This section highlights unique aspects of applications that are either (1) non-client server applications, or (2) single server and a single UI client applications.

1. Single server/Single UI client applications are those applications for whom every execution run of the application launches a separate invocation of a UI client application and a separate invocation of a single server. In other words, a server serves only one client, in this case the UI client. Very few client/server applications are designed to be single server/single client applications. However, designing ordinary applications of this nature has the advantage of executing the UI client software and the server software on different CPUs connected over the network, and this can have desirable performance attributes.

2. A non-client server application can be transformed into a single server/single client application. A desired partition of a monolithic software application into a client server application would be one where you could separate a portion of the application into (1) a user interface component as the UI client of the application, and (2) the non-ui code into a server application.

Applications belonging to this class can launch the server portion of the application at the invocation of the UI client and terminate the server at the termination of the client as there can be only one client that connects to the server and hence terminating the server will not impact any other user of the service.

Single Server/Multiple Client Applications (SSMC):

Many client/server applications belong to this class of applications. Some significant features of SSMC applications are enumerated. Each client can be the same binary or several binaries with different client functionality.

1. Unlike the SSSC applications it is not possible to terminate the SSMC applications when a single UI client terminates without impacting the execution of various clients that are bound to the server.

2. The single executing server should have the capacity to process requests from multiple UI clients in a meaningful manner.

Multiple Server/Multiple Client (MSMC) Applications:

Some salient features of multiple server/multiple UI client applications are enumerated here:

1. MSMC applications require that for a client application that needs services from several servers, it is necessary for all the servers to be available when the UI client needs the services from these servers.

2. One can abstract multiple UI clients together to form the application user interface for an application where these multiple clients interact with several servers. In the abstract these multiple UI clients can be meaningfully grouped into single client that interacts with multiple servers.

Recapitulation of Relevant and Dependent Technologies:

Data Structures for Persistent Data, Containment of Data Structures, Collections of Data Structures and Data Representing Models in MVC Architecture:

As anyone that has programmed in a structured high level programming language knows, most data is represented using abstract data structures formed using primitive data types such as integers, characters. Modem object oriented programming languages are gradually moving towards object oriented classes to represent all data types including primitive types. The significant aspect of treating data as composed of constituent data elements plays an important factor in the design of the internet widget infrastructure. Therefore, a slightly redundant statement about how data structures are created is written in the document to refresh the reader of this fact. The reader should also take note of this attribute for the data structures that represent a model in an MVC architecture. All data structures themselves can be gathered in collections such as lists, vectors, arrays to create more complex data structures. Equivalently, data structures can be contained in other data structures.

Distributed Object Interfaces, Method Prototypes, Data Structures:

Distributed objects are gaining in popularity for a variety of programming and runtime reasons. Some of the popular distributed object technologies are CORBA, java RMI, DCOM, EJB, E-speak etc. All these technologies invariably use well defined interfaces that expose useful functionality to other applications that attempt to use this functionality. Typically these interfaces are defined using an interface definition language (IDL). The interfaces are comprised of method or function prototypes that define some useful functionality implemented by the servers of distributed or remote objects. A set of methods that have a cohesive association are typically grouped together to form an interface. The clients of these distributed objects obtain a reference to a service object by searching through some name space, and use this reference to invoke the methods on the remote objects as they would invoke the methods on local objects.

An example interface is listed below.

| | |
|---|---|
| Interface banking { | |
| boolean | OpenAccount(bankAccountUserInfo) throws |
| | bankingException; |
| boolean | CloseAccount(bankAccountUserInfo) throws |
| | bankingException; |
| boolean | WriteCheck(currentCheck, currentAccount) throws |
| | bankingException; |
| boolean | PayBill(currentBill, currentAccount) throws |
| | bankingException; |
| boolean | SelectAccount(currentListOfAccounts) throws |
| | bankingException; |
| } | |

Graphical User Interfaces in Distributed Computing:

This subsection explores how graphical user interfaces are used in distributed computing. The subsection begins by describing some important concepts in graphical user interfaces used in distributed computing. The subsection subsequently classifies the way GUI applications are used in distributed computing.

Concepts of Graphical User Interfaces in Networked Computing and Services:

Historically, there have been various approaches to designing graphical user-interfaces in software applications that are distributed in nature. This subsection classifies some of the popular techniques used in the design of graphical user interfaces for networked software into identifiable groups, and explores the implications of each design. This subsection first describes how GUI clients and servers interact with each other. Next, the subsection classifies all the graphical user interface applications as viewed from two programming perspective. The first classification is based on the data representation model for the UI code used to design and render the graphical user interface on the user display. The second approach classifies the applications based on the amount of computation that takes place in the client code of the application and the location of the displays in relation to the computers on which the client applications are executed.

GUI Client and Server Interaction:

The GUI client and the server are typically two distinct processes. The GUI client and the server impact each other's operation. There are some common ways in which the client and the server communicate with each other. The clients and servers tend to use both synchronous and asynchronous communication to effect each other's functioning. Historically, networking protocols such as application layer protocols were used to direct the client server functionality. With the emergence of RPC and distributed object middleware, the same functionality achieved using application layer protocols is accomplished using procedural and object oriented abstractions. This section confines the scope of our description to object oriented primitives that are used to communicate between the GUI clients and the servers. Note that stateless and stateful communication between the clients and servers should not impact the design and analysis of internet widgets.

The (java) primitives that are used herein to describe various types of communication between GUI clients and servers are:

1. Remote method invocation

2. Distributed Events

GUI Client to Server Communication:

The client application would display the graphical elements on a user display for the user to interact. Typically the graphical subsystem generates events based on user actions with the information about the type of the event and the display location where the event occurred. The designer of the client chose to bind the user events of interest to some useful functionality. In a client server application, the functionality that is executed based on a user action may be part of the server element of the application.

The client code can invoke server functionality by remote method invocation of server methods. This invocation can happen in two ways. One way the invocation can happen is where the client registers an event handler that invokes a remote server method. Another similar way to accomplish the same is by having the client generate events that are based on the user interactions and the client code, and the server register to listen to this event and execute a server method as part of the event handler. The first method is used if the client is interested in the contents returned by the server on executing the server method. If the client is not interested in the contents returned by the server executing its code, the second method can be used. The data that the server operates on can be provided either as part of the event object or the arguments passed for invoking the server method.

Server to GUI Client Communication Using the Return Value of the Server Method:

One of the mechanisms that the server uses to communicate with the client is sending a return value to the client when a remote method is invoked. In this method, the client obtains the return value for the method invoked and uses it as appropriate. However, this method of server to client communication does not make it possible for the server to manipulate the client GUI as seen appropriate by the server application logic. Typically, this aspect of server to GUI client communication is not paid attention to by the designer of server software.

Event and Non-event Driven Callback Method of Server to GUI Client Communication:

Besides the form of communication that uses the return value of the server method, the server needs to communicate with the client for other purposes as well. A popular method used in monolithic applications to enable APIs in software libraries to use elements of code created by the application software, typically GUI, is to register as a callback the application code with the API thus making it possible for the APIs to invoke server APIs. Since the interfaces exposed by the server are no different from library APIs, in the abstract the need for callbacks exists even for server applications. As the server may need the client to retrieve information from the user, the clients may register callbacks with the server that the server can use when it needs some information from the user. This registering a callback is the equivalent of server calling a client remote method. As with the server remote method, the server may expect a return value based on the execution of the client remote method or it may not. In situations where the server does not expect a return value, the invocation of the client remote method can be triggered by the server delivering an event that the client listens to.

Note: The above scheme is easy to implement in single server single UI client (SSSC) services. This is due to the fact that the same server can be serving requests from multiple UI clients, and the server requires a mechanism to invoke the client callback that corresponds to the client that is being serviced by the server. Additional infrastructure support is needed to implement the above in non-SSSC types of applications. Internet widget infrastructure described below addresses how this problem can be solved.

Classifications of GUI Clients in Networked Applications:

The following are classifications of GUI clients based on the data representation model for the UI code used to design and render the graphical user interface on the user display:

1. Non-portable binary data that is executable on specific hardware architecture.

2. Portable byte code (java)

3. Portable text based UI code (html, XML) etc.

The following are classifications of GUI clients based on the amount of processing on the client code and the location of displays in relation to the computers:

1. Thick client GUI rendered on local displays

2. Thin client GUI rendered on local displays

3. Thick client GUI rendered on remote displays

4. Thin client GUI rendered on remote displays

The above classification also describes GUI applications that are not distributed applications. Since the focus is on networked distributed applications, non-networked applications are treated herein as special case applications of networked classifications without any loss of generality. As internet-widgets typically resemble networked applications with a client GUI, the choice of dividing how much computation takes place in the client element and the server element of the networked application has a bearing on the applications that will be constructed using internet widgets. Therefore, this section explores various design techniques, and develops guidelines for designing internet widgets with appropriate design characteristics. Some of the terms used in these classifications are defined below. Next, each classification is described.

Thick and Thin Clients:

The amount of computation performed by the client process (as in unix processes) characterizes if a particular GUI client implementation is thick or thin.

Local and Remote Displays:

A client UI is said to be rendered on a local display if the computer on which the client process executes is the same computer to which a display is connected and the graphics of the UI are rendered on this display. On the other hand, if the computer that renders the UI is different from the computer on which the client is executed, then the GUI is referred to as being rendered on a remote display.

The following explores the implications of each of the above-described designs.

Classifications of GUI Clients Based on the Data Representation Model for the UI Code Used to Design and Render the Graphical User Interface on the User Display:

Non-portable Binary Data that is Executable on Specific Hardware Architecture:

Historically all UI client software applications were created using traditional programming models that involved writing the programs in a high level language, and compiling the programs to be executable in specific target hardware architectures. To minimize re-writing code that is commonly used in GUI applications, programmers use pre-compiled middleware (shared and archived libraries) that implement useful functionality and expose this functionality using well defined application programmer interfaces (APIs). The client elements of networked applications were and still are created using the above described approach. Sometimes visual programming tools are used to create the user interface that reduces the programming effort.

Some important advantages to this approach:

1. The client programs created using this approach tend to have good performance characteristics as they tend to be optimized to the specific hardware architectures.

2. Applications are self contained and require minimal support in terms of the applications that need to be running on the computer that runs the client application (i.e the client application does not need other applications to be available and running as is the case with the other two models of client application creation). They however need the necessary hardware and middleware libraries that the applications need as part of the run time.

3. Comprehensive applications with all the popular graphics features can be implemented using this model of client development.

Some important disadvantages to this approach:

1. Non-portability makes the coverage of platforms on which UI clients can run limited by the developer of the client applications of the application.

2. The size of the compiled binaries tend to be large in comparison to the other types of client applications described in this section.

Typical Usage Models:

Typical computers used for this class of applications: Graphics workstations (Unix/Wintel)

Types of applications: All types of graphics clients (thick and thin rendered locally and remotely), and traditional non-distributed applications.

Middleware used: Graphics libraries (X11, Xt/Motif, Microsoft foundation classes, Open GL etc.) & graphics hardware present on the client computer.

Portable Byte Code:

Ever since the advent of JAVA, it has become a popular language and run-time environment used for developing graphical user interface applications that are both monolithic applications as well as client programs of distributed applications. These applications like the non-portable kind of applications are also written in a high level programming language (in this case java). They too use middleware (pre-compiled class libraries) that implements useful functionality that is commonly used by developers of graphical user interface applications. It is in the compilation step that these applications differ from the non-portable binary applications. The byte code compiler compiles the high level programs into byte code. This byte code generated can run on any hardware that implements the run time environment that executes the byte code by interpreting it. Due to the immense popularity of java several platforms implement java run time and hence the portable byte code [TIMF97] programs can be run on almost all hardware platforms. Sometimes visual programming tools are used to create the user interface that reduces the programming effort.

Some important advantages to this approach:

1. The client programs created using this approach as the name specifies tend to be extremely portable (i.e. the same binary can run on multiple hardware platforms)

2. This class of applications tend be smaller in size in comparison to the non-portable applications compiled to the target hardware architecture. This reduces the network latency in downloading a client application to execute the application.

3. The developer productivity is vastly improved due to the implementation of advanced techniques in these modem languages while the legacy environments and languages do not receive the research and innovation communities attention.

4. Comprehensive applications with all the popular graphics features can be implemented using this model of client development.

Some important disadvantages to this approach:

1. These applications tend to have some performance penalties due to the interpreting of the byte code as opposed to executing machine instructions. The difference in performance is diminishing due to some innovative optimization techniques.

2. Application launch latency tends to be larger than it is for the other two types of client applications due to the fact that every invocation of the browser entails launching the java runtime process and the loading of the byte code classes into the processor for execution.

3. These applications require the target platform to implement the byte code interpreting run time.

4. These applications tend to be bigger in size than text based UI applications.

Typical Usage Models:

Typical computers used for this class of applications: Graphics workstations (Unix/Wintel), any computer that implements java run time.

Types of applications: All types of graphics clients (thick and thin rendered largely locally and some times remotely), and traditional non-distributed applications.

Middleware used: java runtime, Graphics libraries (AWT, swing, java 3D etc.) & graphics hardware present on the client computer.

Portable Text Based UI Code:

With the advent of the internet and the web browser, some elements of client side computing in distributed applications are designed using HTML code (and other scripting languages such as Javascript). The web browser can interpret the HTML text and render graphical UI elements as specified by the HTML text. Unlike other two types of client development, there is no compilation of the high level language that converts the HTML text to machine language or byte code. Sometimes visual programming tools are used to create the user interface, which reduces programming effort.

Some important advantages to this approach:

1. As simpler programming constructs are used for creating HTML/Javascript pages in comparison to other types of client programs, it is simpler to develop the client applications. Hence improved developer productivity.

2. The latency of loading an HTML page is much smaller than the comparable latency of executing a java application or a compiled application.

3. The size of the HTML pages are much smaller than both byte code applications and native applications.

4. Typically the user interface can be surrounded with helpful images and text that improve the ease of use.

Some important disadvantages to this approach:

1. The client applications that can be created are limited by the scope of UI features supported by markup languages such as HTML. In other words, more comprehensive client applications cannot be created using this approach as the web-browsers and HTML pages tend to support limited GUI functionality. This is a significant limitation.

2. The platforms on which these applications need to run require a functional web browser that can be invoked by the user.

Typical Usage Models:

Typical computers used for this class of applications: Any computer that runs a functional web browser.

Types of applications: Simple user interface applications that require substantial contextual help to improve the ease of use of client applications.

Middleware used: Web-browser & graphics hardware present on the client computer.

Classifications of GUI Clients Based on the Amount of Processing on the Client Code and the Location of Displays in Relation to the Computers:

Thick Client GUI Rendered on Local Displays:

As described above, thick clients are those client processes that perform large amount of computation on the client side of the client-server divide of the networked application. Depending on the design choices made by the software designers, the client would utilize minimal services from the server and do most of the computing on the client side or do the portion of computing that would benefit from client side computing. Typically, sophisticated graphics hardware connected to the local display resides on the computers that are used for executing client processes. These computers, also called workstations, encourage software designers to do the computing that is graphics intensive in client processes and the other computing on the server side. The client applications of such software applications tend to operate on large data models that require abundant computing power.

Some important advantages to this approach:

1. The application user can benefit from the power of computation available on the computers running client applications.

2. The proximity between computing on large data and the graphics engine provide performance advantages because the latency to write to the frame buffer is less when the processor manipulating the data is connected to the frame buffer by a high bandwidth bus instead of a slow network connection.

3. A user that needs more performance from her client application can upgrade the local computer, and not depend on servers to be upgraded (as users tend to control the choice of their workstations more than shared computing resources that are typically used for running server applications.)

4. The performance of the client applications is not impacted by the vagaries of load on the computers running server applications.

5. The performance of the client applications is not largely impacted by the throughput of the network links that connect the client to the server.

Some important disadvantages to this approach:

1. The performance of the software application cannot be improved for all the users of the application by simply upgrading the computer running the server application.

2. This model of software design parallels a monolithic application more than distributed application as most of the computation is performed on the computer running the client with the server providing token services.

3. Not very easy to optimize the computing resources shared by the entire group, as the computers that run clients are reserved to run applications of a particular user.

Typical Usage Models:

Typical computers used for this class of applications: Graphics workstations (Unix/Wintel)

Types of applications: Graphics intensive clients, and traditional non-distributed applications. (Applications tend to belong to the non-portable binary data applications or portable byte code type of applications.)

Middleware used: Graphics libraries & graphics hardware present on the client computer.

Thin Client GUI Rendered on Local Displays:

In the thin client GUI model, most of the computation performed by the distributed applications is carried out by the server program of the application. The client program is primarily intended to provide the necessary functionality that will allow the user to drive the work flow of the application where the actual work is performed by the server element. The processes that execute the client applications or the client application processes themselves run on the same computer as the one to which the display is connected.

Some important advantages to this approach:

1. The performance of the application is not overly impacted negatively due to limitations in the compute power of the computers on which client applications are run.

2. Helps in better utilization of available computer resources as the fewer shared computers that run servers can be harnessed to capacity more easily than unshared computers that run client applications.

Some important disadvantages to this approach:

1. Individual users cannot improve performance by upgrading their computers as the client code has limited impact on the performance of the application.

2. The graphics acceleration hardware typically resides on client side computers, and it is difficult to defer large amounts of computation to the server if the application is intrinsically graphics intensive as server hardware does not usually help with improving performance of graphics applications.

3. The throughput of the network link connecting the server to the client has a bearing on the performance characteristics of the application.

Typical Usage Models:

Typical computers used for this class of applications: Any type of workstations (Unix/Wintel)

Types of applications: Non-graphics intensive clients, and light weight clients that are solely responsible for user interface functionality. (Applications tend to belong to all three categories of applications: the non-portable binary data applications or portable byte code type of applications or portable text based UI code.)

Middleware used: Web browsers, UI libraries & graphics hardware present on the client computer.

Thick Client GUI Rendered on Remote Displays:

When client applications render graphics elements on a display connected to a different computer than the one on which the client application is executed, the factors that impact these applications' performance characteristics are the quality of the graphics hardware present on the computer connected to the remote display and the network throughput between the client application executing computer and the remote display computer. Typically a software solution makes it possible to render clients executed on one computer to be rendered on remote displays. One such solution transfers the contents of a local frame buffer to the remote display, and delivers the user interface events that happen at the remote display to the client computer to react to the operations performed by the user. Another technique that makes the same solution possible is one where the client through a library can directly address the remote display frame buffer, and has access to the events that take place on the remote display (X-windows). The availability of graphics accelerating hardware on the remote display computer, with appropriate middleware makes it possible for certain remote rendering protocols to keep the data model representing the graphical element to be closer to the display than where the client application is executing. If on the other hand the client computer has the necessary graphics acceleration hardware and the remote display computer does not, then the frame buffer contents that are required to render on the display are transferred over the network while the graphics model is manipulated on the client computer. In situations where the graphics hardware does not exist on both the client computer and the remote display computer the performance of the client application will be sub-optimal in comparison to the other scenarios, if the execution of graphics intensive applications is feasible at all.

Note: It is possible to execute GUI clients on the computers connected to the remote display. This makes it possible to display GUI for both local clients and remote clients. Without the software that makes it possible for displaying clients on remote displays, displaying clients that are executed on different clients is not feasible.

Some important advantages to this approach:

1. It is possible for multiple users that do not have a workstation with sophisticated graphics accelerator to benefit in performance by sharing workstations with graphics hardware.

2. Any application that can be executed on the client computer can be displayed on any display even if the client application cannot be executed on the computer connected to the remote display. (X-windows applications displayed on PCs, X-terminals)

3. It is possible to display clients executed on different computers to be displayed on the same remote display.

4. The other advantages are similar to the advantages of thick clients rendered on local displays.

Some important disadvantages to this approach:

1. Network latency between the computer that executes the client application and the remote display is additional overhead that can diminish the quality of the user experience due to performance deterioration.

2. The rest of the disadvantages are similar to the disadvantages described for thick client application rendered on local displays.

Typical Usage Models:

Typical computers used for this class of applications: Any type of workstations & X terminals (Unix/Wintel)

Types of applications: Graphics intensive clients, and traditional non-distributed applications. (Applications tend to belong to the non-portable binary data applications or portable byte code type of applications.)

Middleware used: Graphics libraries & graphics hardware present on the client computer or the computer tethered to the remote display.

Thin Client GUI Rendered on Remote Displays:

The thin client applications that are rendered to the remote display are no different from the thin clients displayed on the local display. The only significant difference is that there exists a network link between the client computer and the computer connected to the remote display.

Some important advantages to this approach:

1. Any application that can be executed on the client computer can be displayed on any display even if the client application cannot be executed on the computer connected to the remote display. (X-windows applications displayed on PCs, X-terminals)

2. It is possible to display clients executed on different computers to be displayed on the same remote display.

3. The other advantages are similar to the advantages of thin clients rendered on local displays.

Some important disadvantages to this approach:

1. Network latency between the computer that executes the client application and the remote display is additional overhead that can diminish the quality of the user experience due to performance deterioration.

2. The rest of the disadvantages are similar to the disadvantages described for thick client application rendered on local displays.

Typical Usage Models:

Typical computers used for this class of applications: Any type of workstations & X terminals (Unix/Wintel)

Types of applications: Non-graphics intensive clients, and light weight clients that are solely responsible for user interface functionality.

Middleware used: Web browsers, UI libraries & graphics hardware present on the remote display computer.

Graphical User Interfaces, User Work Flows, State Machines, and Start States:

A graphical user interface of a user interface application enables users to direct their workflow using the functionality that is supported by the software application. The workflow of tasks performed that are contingent on user inputs models very closely with state machine such as deterministic and non deterministic finite state automaton. The graphical presentation of the GUI application rendered on a display can be construed as a state in a state machine. The events both user driven and non-user driven that affect the presentation are analogous to the input symbols in a finite state machine. The tasks performed based on the user actions is analogous to the output symbols generated. The transition function that defines how a state transition takes place from one state to another based on the input symbol generating an output symbol is similar to the software application. With any GUI application the elements that are needed for the user to drive some functionality of an application should be transitionable from the start state of the GUI application. Depending on the GUI designer, the starting presentation will contain certain visual elements that will be called the start state of the GUI application. All the visual states that a user is expected to use to drive the work flow of the application have to be transitionable from the start state for the user to interact and drive the work flow.

Definition:

Start state of the GUI application is the set of visual elements that are displayed on the launch of a GUI application.

III The Rationale for an Internet Widget:

This section first describes the problems encountered in integrating pre-built software modules. Next, definitions of service development and integration are provided. Current techniques are that used in integrating servers to create services are described. Finally, the section describes problems with integrating services in this manner. The problems of integration provide a rationale to create the new abstraction of software development called internet widgets. In latter sections, it will be shown how using internet widgets solves the problem of integration without the consequent difficulties that exist if this approach is not chosen.

The Problem Description of Integrating Pre-built Software Modules:

This subsection describes some of the problems encountered in creating software solutions by integrating certain types of software modules. The problems are illustrated using an example scenario where a software solution is being created by the integrator using pre-built software modules.

It is not too uncommon for one to come across a situation where there are multiple servers S={s1, s2, . . . } used in an enterprise computing environment, where each server provides some useful functionality. Multiple servers are also utilized in delivering software applications over the internet. It is also not uncommon for situations where some servers when combined in a meaningful fashion can provide a service that is greater in value than the value provided by the individual servers. This section first defines the terms server creators, service creators or server integrators and service deployers and users. The section next describes the software development process for server creators and server integrators, and explores how related servers are created by disparate server developers. Some possible ways are described in which services are created by integrating multiple servers with the help of an example using two servers. The section provides an analysis of the problems in integrating servers in the manner described. Finally, the section proposes a way in which the servers can be integrated in service creation that addresses the problems described above.

Definitions of Service Development & Integration:

Server Application Developer:

A server application developer is a software developer that creates a server application or server and client applications of a service that implements some well defined functionality.

In a lot of ways, a server application developer is quite akin to the creators of software libraries in single executable non-networked applications. Just as the software library creator designs interfaces (APIs) to meaningful functionality to be used by different types of application developers, a server creator too has to do the same for networked applications. The server developer can expect to have multiple software applications to use the server developed by them. A server developer has to foresee or understand how the server can be used by a variety of users of this server, and the various environments in which the server will be used and accordingly design the interfaces that allow the clients of the server to make use of the functionality exposed by the server. A server can be implemented using several programming models and constructs such as sockets, RPCs, and distributed objects as described earlier. To simplify the scope of the discussion, the focus will be on distributed objects. The discussion could be very easily extended to servers created using any of the programming models and constructs.

Service Creator or Solution Integrator:

A service creator or solution integrator is a software developer that creates a networked software solution using one or more servers. The service creator creates the software solution as a service by creating a client UI application that uses the functionality implemented by the several servers.

The server integrator, much like the software solution developer of non-networked applications, relies on some application programming interfaces (APIs) implemented in software libraries to create a useful application. Based on the requirements specified for the problem that is being solved by the solution creator, appropriate available libraries are chosen and additional software is written using these libraries to solve the problem at hand. Similarly, a service creator too creates a client UI application that utilizes available network server objects. In circumstances where necessary server objects are not available, the integrator develops the necessary functionality either as a local server object or incorporates the functionality as part of the client code.

Service or Solution Deployer:

Service or solution deployer is the one that takes the software that comprises of the application client and all the necessary servers and installs them on computers in a deployment environment so that the users can use them.

In circumstances where the solution or the application being deployed relies on already deployed servers that are being used as part of another service in the deployment environment, then those servers are used for the deployment of the new application as seen appropriate by the designer of the service.

Software Development Process for Server Creation:

A service developer is primarily a developer of the server application for some service. For certain servers, developing a client application to provide a complete service may be useful. In such circumstances, the server developer also develops the client application of a service. For most servers that are typically implemented in general, the server developer develops at least a token client that can be utilized for testing the functionality exposed by the server thus implementing the elements required by definition to implement a service. This subsection outlines the process that is used to develop a server, and the process used to develop a service that uses just the server being developed. For the simplification of the discussion, the subsection will be limited to a discussion of the implementation of servers that does not depend on other servers that are already implemented by some other server developer and are available for usage.

1. Obtain the requirements for implementing a server as a distributed object.

2. Identify middleware that can be leveraged to implement the functionality of the distributed object.

1. Identify class libraries of local objects to be used in the creation of the server object.

2. Identify system libraries to be used in the implementation of the server object.

3. Purposely skipped is a discussion on the reliance on distributed objects in the creation of a distributed object. This will be explicitly covered in the service integration section.

3. Implement the server object using the middleware.

4. Implement a usable client that utilizes the distributed object functionality to complete the implementation of the service.

Current Techniques Used in Integrating Servers to Create Services:

Possible Ways in Which Servers are Integrated:

A server integrator uses as many existing servers as one needs to create a software solution as a service. Usually the software integrators use the servers of available services in the creation of the solution. It is unusual for a client created as part of one application or service to be used in a different application or a service. There are two important ways in which the functionality exposed by various servers can be integrated. The two ways are:

1. server side integration

2. client side integration

For purposes of illustration, two servers s1 and s2 are to be integrated. The functionality exposed by these two servers are described by the following interfaces:

Interface s1 {

Void X1();
Void Y1();
A Z1();

}
Interface s2 {

Void X2();
Void Y2();
B Z2(A);

}

Server Side Integration:

If the functionality that is to be created by integrating the two servers s1 & s2 can be used as part of several services, then server side integration is used to integrate servers s1 & s2 to create a third server s3.

Where
Interface s3 {

Void X3(); // uses s2.Y2() and s1.X1()
Void Y3(); // uses s1.X2()

}

The UI client application implementation that completes the service implementation uses the interfaces of s1, s2 & s3 as required by the service created.

Client Side Integration:

If the integrator that creates an application does not see a need to create a server that can be used by other applications, then the client directly uses the interfaces s1 & s2 to create the client c.

A small snippet of code that illustrates the client side integration is,

M=S1.Z1( );

N=S2.Z2(M);

The two servers S1 & S2 are oblivious to each other's existence. Typical in this type of client side integration technique used in contemporary service creation is the usage of returned value of server methods for server to client communication. As there is no systemic support for callback or event driven mechanism that can allow the server to drive the UI work flow, it is not a technique that is currently used. Internet-widgets by enabling the server to client communication using callbacks and events make it possible for interesting ways in which client side integration can take place.

Note: If two integrators try to create two different services that use server s1 and s2 functionality then they have to both create two different UI client applications that use the interfaces from servers s1 & s2.

Software Development Process for Service Creation or Server Integration:

Here is the set of things that a service creator or solution creator goes through.

1. Obtains the requirements for the solution to be created.

2. Identifies servers (distributed objects) that can be used in the creation of the solution. (See creating related and dependent software services to understand how this may be done)

3. Comes up with an integration strategy that is either client side integration or server side integration.

4. Creates a client UI application that uses the various servers that are integrated for the creation of the solution.

Creating Related and Dependent Software Services:

As described in the earlier sections, often times new services and servers are created that use functionality from existing servers. One problem that every software developer encounters is to figure out what functionality has to be newly created and what existing functionality can be utilized in the creation of the final solution. Several factors contribute in determining whether to use available software middleware such as servers or to create something from ground up. Factors such as the quality, scalability, performance, ease of use, economics are used in the decision making.

In order to determine whether to implement a server and service using related services, often times software developers rely on their knowledge of available server middleware. However it is fairly common for software developers to re-invent same functionality even when they would rather obtain this software from elsewhere only because they did not know of the existence of such software. A mechanism that enables software developers to discover available middleware and servers related to the general areas to which their solution belongs tremendously reduces re-inventing available software. This would be particularly significant to solution creators and service creators. An example of how the work of creating a banking related service may change depending on the knowledge of existing software is described.

Examples of Banking Services:

Assume that a particular software developer had created a banking service, and a second software developer is attempting to create a solution that helps in financial planning. This example will walk through how the second developer implements the financial planning solution.

The first service is a banking service that allows one to interact with one's bank account using a service sc1 {{uc1},{s1}}, where the server s1 is made available from some network location and the UI client application uc1 has a visual user interface that allows one to perform operations on the account.

The interface exposed by the service s1 is

| | |
|---|---|
| Interface banking { | |
| boolean | OpenAccount(bankAccountUserInfo); |
| boolean | CloseAccount(bankAccountUserInfo); |
| boolean | WriteCheck(currentCheck, currentAccount); |
| boolean | PayBill(currentBill, currentAccount); |
| boolean | SelectAccount(currentListOfAccounts); |
| bankAccountUserInfo | getBankAccountUserInfo(); |
| currentCheck | getCurrentCheck(); |
| currentAccount | getcurrentAccount(); |
| currentBill | getCurrentBill(); |
| currentListOfAccounts | GetListOfAccounts(pathOfUserStorageSpace); |
| } | |

The client user interface application has elements that trigger invocation of several methods on the service. Using the DOM/MVC model for creating the user interface, this client UI is implemented to have a work area that displays the model being acted upon, and the various operations that are described by the interface are bound to visual elements such as menu elements or toolbar buttons that trigger the operations of the work flow that enables users to perform the actions that the user needs to perform.

The UI elements when acted on, if the data is already available simply invoke the interface methods to perform the actual actions supported by the service. In scenarios where the data needed to invoke the methods is not available, the UI code interacts with the user to obtain the necessary information to invoke the methods.

The second software developer is attempting to develop a fictional financial planning software with the following features.

1. Generate a report of all expenses incurred in a given period of time

2. Forecast expenses for next year

3. Plan allocation for groceries

As this fictional software requirements are conveniently crafted to illustrate how services can be built using existing services or servers, it is not surprising to notice the need for a software solution that operates on classes that are also operated on by the already implemented banking service. However, adding some functionality to an existing implementation of a server is not an uncommon situation in software development.

In order to create the software solution, the developer could chose one of the following options:

1. Create the equivalent of the server in the first banking service and the features required for the software solution as a single service and implement the user interface client application. (This may be necessary if the implementer of the first service does not export the interface for other services to be built using the server of this service.)

2. Build a second server with the interfaces that complement the first service's server interfaces to provide the complete solution and create a UI client application that implements the user interface elements as needed for the elements of first service exposed in the client application and the user interface elements that drive the functionality of the second service.

A plausible interface definition for the server of the financial planning service is: The interfaces exposed by the service s2 are

Interface budgeting {

GenerateReportOfExpenses(currentListOfAccounts);
ForecastExpensesForNextYear(currentListOfAccounts);
PlanAllocationForGroceries(currentListOfAccounts);

}

The design of the GUI for the client is designed by binding visual elements to invoke the interfaces supported by the server of the financial planning service and the server of the banking service. The financial planning service UI like the banking service have a work area and some visual elements such as menu elements and toolbar buttons that trigger the direct invocation of the methods supported by the interface or interact with the user to gather the information necessary to supply to the interfaces that perform the actual work.

Some of Problems in Integrating Services Using the Above Techniques:

This subsection describes the problems encountered in integrating services using the above techniques. The subsection first enumerates these problems and then describes in detail the difficulty in integration.

1. Re-implementing client functionality by each solution creator.

2. Software development effort is needed for any server integration.

3. Client implementation done by non-experts for a given server.

4. Lack of infrastructure support that enables clients to register callbacks with server applications.

5. Difficulty in integrating client call backs for various servers of the services by client implementers that are different from the server implementers.

6. Inability to plug different user interfaces.

7. It requires non-trivial effort to extend controller functionality of a model in the MVC abstraction.

8. Difficulty in binding various interfaces used by servers that are part of an application.

9. No structured way to launch an application that uses several servers that are not already launched at the time of client invocation.

10. No structured way to encapsulate data that belongs to the application that uses multiple servers.

Re-implementing Client Functionality by Each Solution Creator:

When an application service is created using one or more servers, conventional software development requires that a separate client UI application that is integrated with all the servers involved in the service be created. In effect every new service created using existing servers requires a new client UI application. Often times, the same UI work flow helps a user interact with a server no matter which service is being used to exercise the server. This requires one to implement similar UI functionality as part of the client UI application for every service created. Since the UI functionality that is similar for all the services that exercise a server, it would reduce in the amount of client functionality to be implemented if there is a way to reuse the UI code.

Substantial Software Development Effort is Needed for any Server Integration:

Using the contemporary techniques for server integration requires the server integrator to invariably write a substantial amount of additional software as part of the integration effort. In the internet widget infrastructure based integration of servers, it will be possible to integrate servers without reduced software development.

UI Client Implementation Done by Non-experts for a Given Server:

As the server creator need not be the service creator, the UI client application is invariably implemented by people that did not develop the server. If the server creator can contribute in the development of the UI that drives the server functionality, then there can be a greater expectation of superior user interface considering the server creators comprehend the most about the assumptions that are built into the server implementation.

Lack of Infrastructure Support that Enables Clients to Register Callbacks With Server Applications:

Due to the lack of infrastructure that enables clients to register callbacks with server applications, the server cannot interact with the user via the client and has to rely on the client understand the server internals more than is necessary. For instance, if an authentication server needs to prompt the user periodically for authentication, it would be easier if a callback can be invoked by the server that presents the user with a user interface that prompts for user information when appropriate server method is invoked. The client application does not need to track when the server method needs to interact with the user.

Difficulty in Integrating Client Call Backs for Various Servers of the Services by Client Implementers that are Different from the Server Implementers:

Since it is the server implementers that understand when to retrieve user information using callbacks, it is easier for the server creators to know when to invoke callbacks that are registered by clients than to facilitate a way for the client to drive the UI requirements of the server. The client developers will need to comprehend the internals of the server semantics, or the server design has to work around this limitation in a less elegant way.

Inability to Plug Different Client User Interfaces:

Since the client user interface applications are holistically constructed for the entire application that uses all the servers, it is difficult to switch client user interfaces for different servers without a re-write of the client application. A mechanism where a server's UI can be incorporated into client UI applications in a pluggable manner makes it possible for those familiar with driving the UI based on the server to choose to use the same UI in a different service that uses the same server. For instance, the banking and financial planning example could allow a user that is familiar with the UI that drives the banking server to use the same UI while using the financial planning software as well if the UI from the banking application can some how be pluggable into the financial planning client UI application.

It Requires Non-trivial Effort to Extend Controller Functionality of a Model in the MVC Abstraction:

As described in the banking example, the MVC abstraction can be extended to distributed computing where the combination of the server and the client model MVC for a visualizable data object. If a new operation were to be added as a new server method that can be invoked, then the way this can be implemented is similar to creating related software services. And this requires substantial new software to be created. Use of internet widgets should be able to reduce the effort to extend the controller functionality of the MVC abstraction.

Difficulty in Binding Various Interfaces Used by Servers that are Part of an Application:

In a networked environment if multiple servers are needed as part of a service instantiation, and there are several services like this then it is necessary for each service to bind the client UI applications to the specific set of servers that correspond to this service. The current infrastructure does not provide an adequate support for coherent managing and administering the bindings between client UI application and the various servers.

No Structured Way to Launch an Application that Uses Several Servers that are Not Already Launched at the Time of Client Invocation:

As described above some of the servers that are used by the client UI application of a service are used only by that particular instantiation of the service, while others are used by multiple services. It might be necessary at the time of the launch of the client UI application to instantiate the servers that are not already launched in the network environment where the service is launched. There is no infrastructural support for facilitating this. Internet widget infrastructure will make this possible.

No Structured Way to Encapsulate Data that Belongs to the Application that Uses Multiple Servers:

As each server that a service uses can create and manipulate some data, it is quite likely that the locations where each server writes server specific data will not be well encapsulated in a meaningful structured location.

Proposal to Integrate Services:

A service integration framework is proposed that facilitates application creation in a way that service integrators do not have to encounter the above described problems. This framework is built around the abstraction of an internet widget. The next section defines aspects of internet widgets and describes a framework for internet widget integration.

IV Description of Internet Widgets

In order to describe aspects of internet widgets, it is useful to first describe three concepts: 1) instantiable distributed objects (IDOs), 2) layered object oriented programming, and 3) objects executing in multiple planes of execution. Next, a formal definition of an internet widget is provided. The section then provides details of infrastructure support used to create internet widgets. The next subsection describes designing practical Internet Widgets. A complete subsection addresses the issues of transactional computing in internet widgets. Another subsection describes several additional internet widget concepts that are very useful to facilitating the usage of internet widgets in actual application development. Finally, the section describes how the internet widget infrastructure is partitioned in order to be able to deploy the infrastructure software in simple bundles.

Instantiable Distributed Objects:

One of the new concepts that is important in developing the internet widget abstraction is the instantiation of distributed objects. This concept is developed by describing what it means to instantiate objects as services. Next, the subsection defines an instantiable distributed object. Also described are practical constraints involved in the instantiation of distributed objects. Finally, the subsection describes an infrastructure that facilitates the instantiation of distributed objects.

Instantiating Objects as Services:

Among the contemporary technologies of distributed objects, there is a significant distinction between distributed objects and local objects.

Instantiation of a local object or obtaining of a reference to a local object is done in the programs that use the instantiated objects. Typically, in distributed objects the instantiation of an object is done separately by some deployment procedure for deploying a distributed object (CORBA, EJB, E-speak etc.), and a reference to the server object is used by a client of the program just as the client would use local objects”.

For example the code snippet for instantiating a local object and obtaining a reference to that object may look like the following.

File abc=new File(“/tmp/foobar.java”);

File def=abc;

In distributed computing the deployment is done separately by a deployer registering itself in a namespace that is visible to the distributed server object and the clients of this distributed object.

Here is an example of a distributed object that implements an interface exposed by a distributed object.

Interface s1 {

Void X1(SAINamespace, M, N);
Void Y1(SAINamespace, O,P);
A Z1(SAINamespace);

}

The server actually implements the methods defined in the interface.

And the code of the implementation of these methods would look like: Void X1(SAINamespace, M,N){

. . . .
Some useful functionality
.
.

}
Void Y1(SAINamespace, O,P){

. . . .
Some useful functionality
.
.
}

A Z1(SAINamespace){

. . . .
Some useful functionality
.
.
return A;

}

The server object would register the server with the name service with the following code.

Connection=ConnectToObjectTechnologyMiddleWare( );

Connection.Register(Universalnamespace, “Servername”, s1);

The client on the other hand would write code similar to the following lines.

Connection=ConnectToObjectTechnologyMiddleWare( );

s1 a=(s1)Connection.Findserver(“Servername”);

And now the client stub code intercepts an invocation such as

a.X1(SAINamespace,M,N);

and marshals the arguments and instructs the server to execute X1(M,N) on the server.

From the above example, it is clear that the interface s is analogous to a class File( ) and the deployment of a server object is equivalent to instantiating an object in a program. Both interface and the class define a distributed and local object. The instantiation of an object using the class definition creates an instance of a class that is useful in a program and the scope of visibility and availability of the object instantiated is defined by the programming language semantics and the program itself. In the case of a distributed object, any network peer that can obtain a reference to the instantiated service can invoke the methods of the interface implemented by the distributed object.

The current state of the art definition and implementation of object oriented languages allow classes to define methods and member classes. It is possible to manipulate the members of a class that is instantiated as an object. The interfaces that are used to define a distributed object on the other hand use methods exclusively to manipulate the distributed object. A similar restriction can very easily be imposed on the classes to make them semantically equivalent without any loss of functionality, as a class can very easily return a reference to the internal member through a getXYZ( ) method thus enabling programs to manipulate the values of an internal member.

One of the common reasons for having distributed objects deployed separately is the fact that the distributed objects are treated as servers that are already instantiated to be discovered by the clients that are network peers. These client objects depending on access policy governing access to the distributed object client applications will be able to use a distributed server object. Even in component based technologies such as EJBs and the component model specification in CORBA that allow clients to instantiate the components called beans programmatically through the create method, the deployment of the component in the name space is a separate step. This method of instantiation of distributed objects has some disadvantages. In particular, the instantiated or in EJBs case created bean in its incarnation is bound to the scope of the client program that creates, and is not explicitly addressable as a reference from other related clients. In other words, a bean created by a client is not in turn accessible to other distributed object clients to invoke the methods of the instantiated bean. More detailed discussion on this aspect can be found in the sub section titled “Need for executing internet widgets as separate processes”.

In the abstract, the distributed object server can be programmatically deployed on a particular host by the very client that intends to use a distributed object. Until now the necessary framework to instantiate a distributed object has not been created in the popular standard distributed object technology frameworks.

The semantics of instantiating a local object is described by the various programming languages. Typically the semantics of the keyword “new” describes how local objects can be instantiated. A similar keyword such as “remotenew” based construct may be conceived of for deploying a new instantiation of a distributed object with additional semantics and syntax that is appropriate. However extending a language is fairly difficult to do. If the same can be achieved with the existing language primitives, then that would be much easier to implement. This subsection shall describe in greater detail how distributed objects may be instantiated.

Definition of Instantiable Distributed Object (IDO):

An instantiable distributed object is a distributed object that can be instantiated (i.e. deployment and creation of the distributed object ) by the client application that needs the functionality implemented by a distributed object.

It may useful to apply constraints on the ways in which distributed objects can be instantiated programmatically to simplify an embodiment. Other embodiments may incorporate other semantics.

The Features Used in the Instantiation of New Distributed Objects:

This subsection identifies aspects of object oriented and component oriented programs that help identify the constraints in the distributed object instantiation problem. These constraints are then enumerated. The terms constraint or restriction are used herein to describe features that may be required by a particular embodiment of the present invention, but the terms are not intended to limit all embodiments of the present invention by requiring that they possess all these features.

In persistent components such as entity beans in Enterpise Java Beans technology or simple beans in Java Beans technology [SUN97], a component is capable of saving the state of an execution of an entity bean or a simple java bean, even though in the case of the entity bean it is deployed as a distributed object. Typically, beans and other components can be made to save state by serializing the instantiated object (in this case local object), and are able to be restarted with the saved state reflected in subsequent instantiations. In effect there exists a way to construct a component or an object using a serialized persistent object from some storage location (such as a filename from a fileserver or some location in a database). Such a location is referred to herein as the location of the persistent object or LPO.

In the abstract instantiation of an object can be separated into two distinct operations. The first operation in the object instantiation can be viewed as the creation of the object, and the second operation is the initialization of an object. The creation of the object is equivalent to calling an empty constructor with no arguments. The initialization could involve several methods in which the created object can be populated with the data that is needed to invoke any other method exposed by the object. Typically, object oriented languages combine the semantics of initialization and creation into the construction of an object by syntactically permitting constructors of different method prototypes.

Example of a creation:

File f1=New File( );

And an example of initialization step could read:

f1.init(filename);

or

f1.init(filename, openmode);

Instead traditional programming languages would allow one to construct the object by combining creation and initialization in the following manner.

File f1=new File(filename);

Or

File f1=new File(filename, openmode);

Now for the constraints:

1. Each instantiable distributed object (IDO) implements an initialization method that takes the location of a persistent object (LPO) as an argument and initializes itself.

2. All instantiable distributed objects (IDOs) are instantiated in a two step process that involves separate creation and instantiation steps. In other words, all instantiable distributed objects need to implement at least the init method that takes the LPO as an argument, and only an empty constructor in the traditional object oriented programming.

3. All the member elements of instantiable distributed objects are not accessible by definition unlike public member elements of a local object instantiating a class.

Distributed Object Instantiator:

Instantiable distributed objects can be instantiated using the distributed object instantiator class. The DOInstantiator class is implemented as part of the internet widget infrastructure. Some of the methods that will help in the instantiation of an instantiable distributed object (IDO) are outlined.

Class DOInstantiator {

InstantiableDO instantiate(IDOClassName, IDOObjectName, LPO,

scheduler, namespace,
IDOClassImplementationDefaultLocationPathName );

InstantiableDO instantiate(IDOClassName, IDOObjectName, LPO,

hostname, namespace,
IDOClassImplementationDefaultLocationPathName);

InstantiableDO instantiate(IDOClassName,

IDOClassImplementationPathName,
IDOObjectName, LPO, scheduler, namespace,
IDOClassImplementationDefaultLocationPathName);

InstantiableDO instantiate(IDOClassName,

IDOClassImplementationPathName,
IDOObjectName, LPO, hostname, namespace,
IDOClassImplementationDefaultLocationPathName);

}

IDOs are instantiated using one of the above methods.

The various elements of the instantiate methods are briefly described.

InstantiableDO:

All instantiable distributed objects implement the InstantiableDO interface (a utility adapter class can be implemented that others can benefit from). The return value is an instantiableDO that can be cast to the specific class that is being instantiated.

IDOClassName:

Instantiable distributed object class name is the class that is to be instantiated. In the absence of the IDOClassImpelementationPathName argument the implementation of instantiate discovers the implementation path name through hitherto unspecified heuristic. The IDO class name is equivalent to the class name in traditional OO programming languages.

IDOClassImplementationPathName:

This variable can be used to specify exactly which binary is to be used for executing the client element and the server elements of distributed objects.

IDOClassImplementationDefaultLocationPathName:

The default location is the location on the internet where the package containing the implementation of the internet widget is made available by the implementor of an internet widget.

IDOObjectName:

IDOObjectName is the character string that is used to register the distributed object. This name is similar to the name used in the deployment of traditional distributed objects for deploying server objects. The variable name to which an instantiated object is assigned in traditional object oriented programming is the equivalent of IDOObjectName. Programmatically, it would be easier for tracking the name of the variable to which the instantiate method return value is assigned is the same as the string used for IDOObjectName even though this is not necessary.

LPO:

LPO is the location used for storing the persistent object. This value has to be used even if the initialization of a persistent object is not going to use a previously serialized version of the distributed object. The instantiable distributed object keeps a copy of the pathname so that any one with a reference to the IDO can figure out where the object is persistently stored.

Hostname:

Hostname is the host computer on which the server object of the distributed object is executed. This also requires that the instantiate method can instruct the host machine to execute the class that implements the server distributed object. This is implemented as a distributed object called RemoteInvoker that is already deployed and running with a name “RemoteInvoker.hostname” on all the hosts that can execute distributed objects.

RemoteInvoker:

RemoteInvoker is a special distributed object that is already instantiated (deployed, constructed and registered with the global namespace) on all the hosts on which distributed objects can be instantiated. A reference to a more formal specification is to be provided.

Scheduler:

In a more sophisticated way to instantiate a distributed object, the instantiator does not pay heed to which host executes the distributed object. This will actually be figured out by a scheduler that can use some load balancing techniques to find out where to execute the distributed object.

Namespace:

The namespace argument specifies which name service has to be used by the instantiate method to register the deployed distributed object. Conceivably there can be several name services that are available for the instantiator to use. Once the internet widgets are described it will become apparent the need for multiple namespaces and their associated services.

instantiate( ):

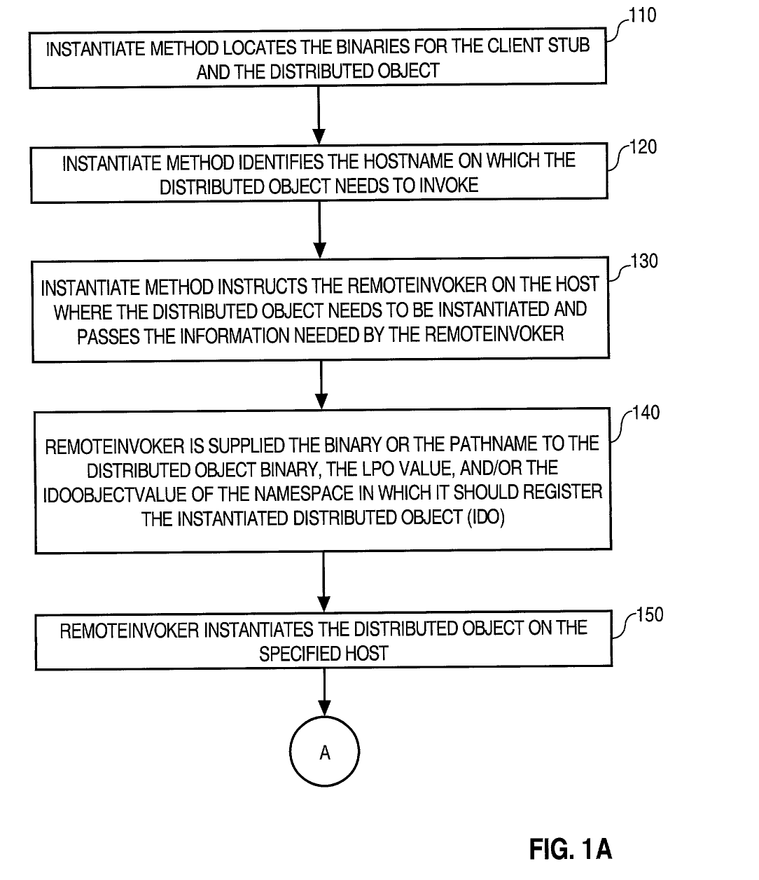

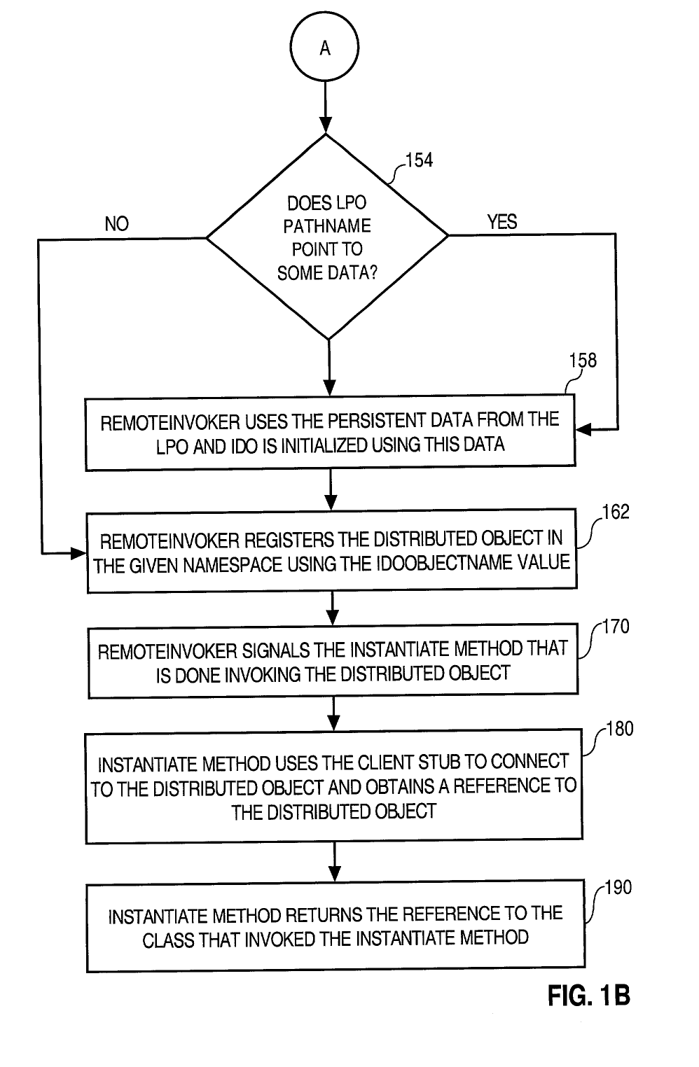

The semantics of the instantiate method are illustrated by a flowchart shown in FIGS. 1A and 1B. Referring to FIGS. 1A and 1B:

At step 110, the instantiate method locates the binaries for the client stub and the distributed object.

At step 120, the instantiate method identifies the hostname on which the distributed object needs to invoked.

At step 130, the instantiate method instructs the RemoteInvoker on the host where the distributed object needs to be instantiated and passes the information needed by the RemoteInvoker. The instantiate method at this stage waits on the RemoteInvoker to complete its task.

At step 140, the RemoteInvoker is supplied the binary or the pathname to the distributed object binary, the LPO value, and/or the IDOObjectValue of the namespace in which it should register the instantiated distributed object (IDO).

At step 150, the RemoteInvoker instantiates the distributed object on the specified host.

At step 154, it is determined whether the LPO pathname points to some data (i.e. file exists or database entry exists). If the LPO pathname points to some data, then control flows to step 165. Otherwise, control flows to step 162.

At step 158, the RemoteInvoker uses the persistent data from the LPO and the IDO is initialized using this data.

At step 162, the RemoteInvoker registers the distributed object in the given namespace using the IDOObjectName value.

At step 170, the RemoteInvoker signals the instantiate method that it is done invoking the distributed object.

At step 180, the instantiate method uses the client stub to connect to the distributed object and obtains a reference to the distributed object.

At step 190, the instantiate method returns the reference to the class that invoked the instantiate method.

Example:

If the LPO contains some meaningful data, then instantiating an IDO is done by the client application using a code snippet similar to the code below.

DOInstantiator myDOInstantiator=new DOInstantiator( );

myJPEGData=(JPEGDataClassClient) myDOInstantiator.instantiate((“JPEGDataClass”, “hostname.abc.def.com:/classes/JPEGDataClass.class”, “myJPEGData”, “hostname.abc.def.com/mydata/myJPEGData.jpg”, “balancedLoadScheduler”, “myApplicationNamespace”, “defaultIWimplemenationhostname.abc.def.com:/classes/JPEGDataClass.class”);

If the file “hostname.abc.def.com/mydata/myJPEGDatajpg” already contains the JPEG data then there is no need for initialization as the RemoteInvoker would instruct the JPEGDataClass distributed object class to initialize itself using the data contained in the myJPEGData.jpg.

If on the other hand the data file is empty, then the initialization step has to be explicitly done by the executing client as below.

DOInstantiator myDOInstantiator=new DOInstantiator( );

myJPEGData=(JPEGDataClassClient) myDOInstantiator.instantiate((“JPEGDataClass”, “hostname.abc.def.com:/classes/JPEGDataClass.class”, “myJPEGData”, “hostname.abc.def.com/mydata/myJPEGData.jpg”, “balancedLoadScheduler”, “myApplicationNamespace”, “defaultlWimplemenationhostname.abc.def.com:/classes/JPEGDataClass.class”);

myJPEGData.init(localJPEGData);

the initialization is done using one of the init methods implemented by the JPEGDataClass distributed object.

Infrastructure implementables:

DOInstantiator class.

RemoteInvoker distributed object. (RemoteInvoker hostname)

Layered Object Oriented Programming:

This subsection discusses several topics related to object oriented programming that will help define layered object oriented programming.

Background on Conventional Object Oriented Programming:

In object oriented programming, it is possible to create objects that leverage from already implemented classes. In particular one can create new classes that use the already implemented classes. There are two ways in which new classes can be created using already implemented classes. For purposes of illustration there are two implemented classes A & B. The two ways in which new classes can be created using the classes A & B is described below. At a very high level, the subsections describe how to create new classes in object oriented programming, and then delve into layered object oriented programming.

Building New Classes Using Existing Classes as Members of the New Class:

Class X {

private A myA;
private B myB;
X(){

myA = new A();
myB = new B();
.
.
.

}
// other methods below

}

In the above example the new class uses the already implemented classes as member variables. Declaring these members and instantiating them makes it possible for the class X to use the existing implementations of these classes. The methods implemented by these classes may be invoked by any of the methods that are implemented by class X because the members are declared as private members. The methods of classes A & B defined in the class X and instantiated as an object are accessible to external objects in three possible ways. The ways in which external objects can access methods of internally defined classes are:

1. If the internal member classes A or B are defined as public.

2. If the methods of class X return a reference to A or B. This will let a class that instantiates the class X to obtain a reference of A or B and then invoke the methods exposed A or B.

3. If X implements methods that internally invoke the methods implemented by either A or B. This implementing of internal member class methods could be done by implementing the interfaces that are implemented by classes A or B.

This section describes constraints for how the internal member classes are exposed to calling objects. In particular, the section describes the constraints that would facilitate layered object oriented programming. Exposing the functionality of internal member classes in an unstructured manner has some consequences that are adverse for designing modular objects. Layered object oriented programming attempts to help design software that is less complex for usability and simpler for design comprehension purposes.

Building New Classes by Deriving or Extending Existing Classes:

Another way to build new classes using already implemented classes can be done using the support within the programming language to extend or derive from base classes. Some programming languages support multiple inheritance & others support single inheritance. In both scenarios, there are some programming difficulties that make this strategy not always suitable, and thus creates a need for building new classes using the strategy of making existing classes member elements of the new class created. The subsection first enumerates the implications of building new classes by deriving from existing classes in the two kinds of programming languages, the ones that support single inheritance and the ones that support multiple inheritance.

In languages that support only single inheritance:

1. The first obvious limitation is the fact that you can only derive from one of the already implemented classes.

2. Unlike in the case where you make existing classes members of the new class, you do not have to implement methods of the class that has already been implemented.

3. Similar to the above point, you also do not have to re-route the events if you do not want to, and still have the users of the derived class listen to the events delivered by the base class (in platforms that support events).

In languages that support multiple inheritance:

1. Even though multiple inheritance allows for one to derive from several classes, it always creates for confusing name collision resolution semantics. The complexity makes programming using multiple inheritance exceedingly difficult.

2. Unlike in the case where you make existing classes members of the new class, you do not have to implement methods of the classes that have already been implemented.

3. Similar to the above point, you also do not have to re-route the events if you do not want to, and still have the users of the derived class listen to the events delivered by the base classes (in platforms that support events)

With that background information, the following subsections describe the constraints that are placed on creating new classes using the two methods described above so that they have the desirable layering properties that simplify the programming model. The subsections first describe the layering constraints using some illustrative examples in both models while also describing the advantages of layered object oriented programming. The subsection later formalizes the constraints and defines the abstraction of layered object oriented programming.

The Description of the Problem of Multiple Containment of Descendants:

In building new classes using already implemented classes, one can observe a containment hierarchy between the new class created and the classes used in its creation.

Rules for Containment Relationship Between Two Classes:

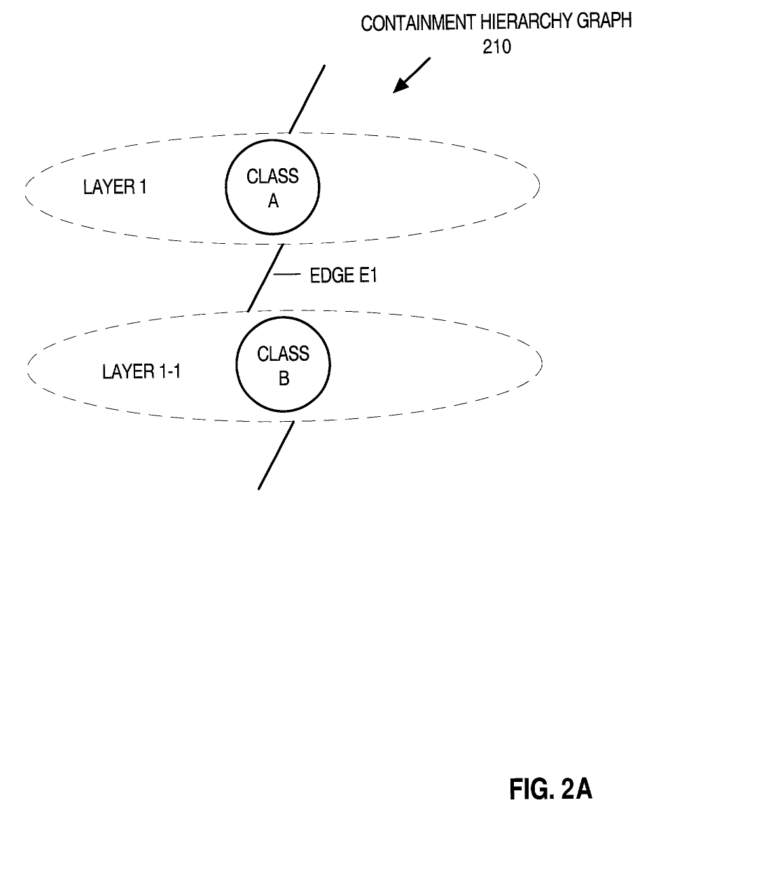

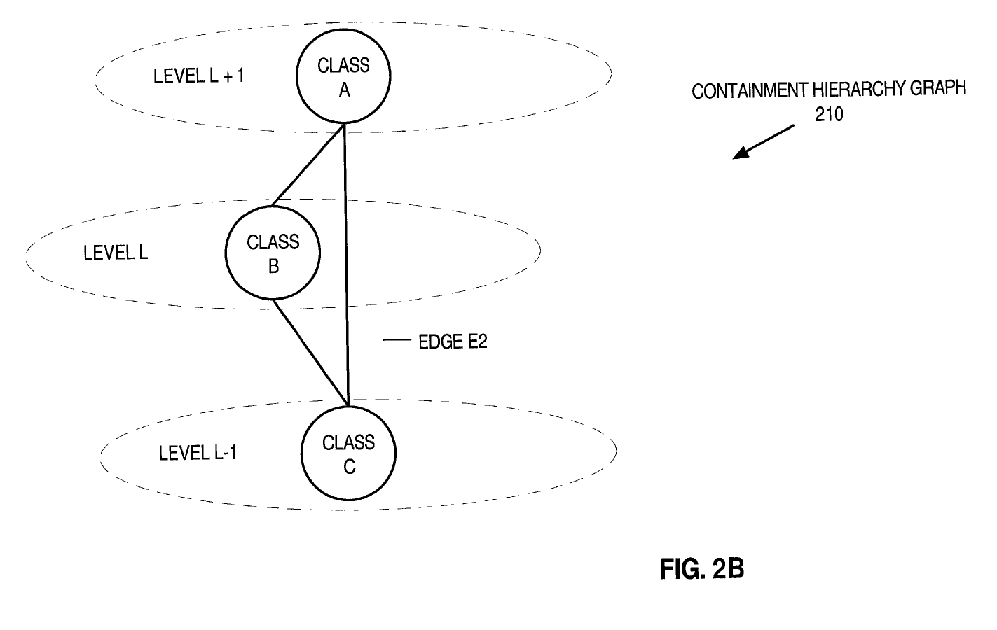

FIG. 2A shows class containment hierarchy 201, which is used to illustrate the following containment relationship rule.

If class A is created using class B, then class A is said to contain class B and class A is in layer 1 and class B is in layer 1-1 in the containment hierarchy. If class B is instantiated by class A, then class B is located at layer 1-1 and class A is located at layer 1 in the containment hierarchy. The order in which classes/objects are instantiated is termed the instantiation order. The layer to which a particular object in a program belongs in the containment hierarchy is solely determined by the instantiation order. However, the interconnection between classes and objects that are represented by edges in a containment hierarchy graph can be made even when two classes do not have an instantiation relationship between each other i.e. one class is not instantiated by another.

The containment hierarchy depicted by containment hierarchy graph 210 is defined at the time of the definition of the new class A. Pictorially the containment hierarchy between class A and B is represented by edge E1 between two vertices that represent the two classes A and B. In every object oriented program, every class is instantiated by another class.

The following two containment hierarchy rules are based on the run time activities of objects using the classes that have been defined. FIG. 2B shows class containment hierarchy 201, which is used to illustrate the containment relationship rule formed by the following rules.

If class C can obtain a reference of the object belonging to class B by invoking a method of an object belonging to class A, whose reference it has, then class B is contained by class C if class C can invoke the methods of class B. The classes A, B and C do not change the levels in the containment hierarchy determined by the instantiation order. A edge E2 is made between classes B & C indicating a containment relationship between B & C.

If class C can obtain a reference of class B and instead of invoking the methods of class B class C registers event-handlers for the events delivered by class B, then class B is referred to as being contained by class C. The containment relationship that would exist between classes A, B, C is the same as that depicted by containment hierarchy graph 220.

It should be apparent from the above discussion that it is possible to have lower level objects contain higher level objects and vice versa by obtaining references and registering event handlers.

The Problem of Multiple Containment:

A containment relationship between the two objects, one instantiating the other, is desirable and un-avoidable. If a given object is contained by (1) another object that did not instantiate the given object or (2) by an object instantiated by the given object, then the given object is multiply contained.

As has been described above it is possible to have more than one object/class contain a given object, in other words be related through a containment relationship besides the instantiation relationship. Allowing such relationships without any constraints poses several programming difficulties. One of the problems occurs with those objects that can be visualized such as the GUI elements. It simplifies to think of a visual object to be contained by another visual object, and not several visual objects. It is possible for a visual element to be contained by several visual elements and each container may want to alter the visual state of the contained elements directly. If this multiple containment were possible, programmatically coordinating the state of the contained object among all the containing objects requires extra-ordinary amount of complicated code.

The design of internet widgets simplifies the programming model by avoiding multiple containment except for a few special cases.

Pictorially, avoiding multiple containment would lead to a containment hierarchy graph that is a tree like structure. In other words, there will not be a cycle in the containment hierarchy graph.

The following sections discuss how to avoid multiple containment.

When Objects are Used as Members of Containing Objects Instead Extending or Deriving from Base Classes:

In object oriented programming that includes event driven programming, it is possible to interconnect objects without any discipline imposed on the interconnections. This subsection describes a way in which objects can be interconnected in an organized way.

This subsection first illustrates the differences between layered object oriented programming and unlayered object oriented programming. Next, the subsection defines more formally layered object oriented programming and enumerates some characteristic advantages of layered object oriented programming.

Layered Object Oriented Programming vs Unlayered Object Oriented Programming:

Event-interconnection Between Instantiated Objects in Layered & Unlayered Object Oriented Programming:

The first difference between layered object oriented programming and unlayered object oriented programming is the way events are routed, as illustrated below.

For purposes of illustration, two classes A & B have the following class definitions:

Class A {

Method1();
Method2();
//Delivers Event1();
AddEvent1Handler();

}
&
Class B implements event1interface{

Method3();
Event1InterfaceMethod();

}

For purposes of illustration, an application is created using the above two classes. Let the application class be class C. There are two alternate ways in which the two classes A & B can be integrated.

Example Code of Unlayered Object Oriented Programming Approach:

The first unlayered object oriented programming approach involves interconnecting of the two classes using the following code snippet.

Class C {

C(){

A myVarA = new A();
B myVarB = new B();
// Interconnect A & B making the event from A be delivered to B
myVarA.addEvent1Handler(myVarB);

}

}

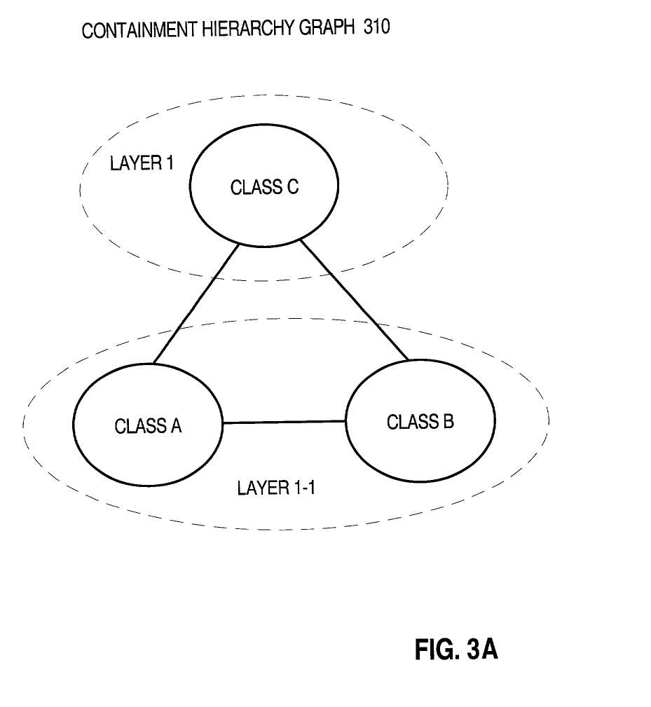

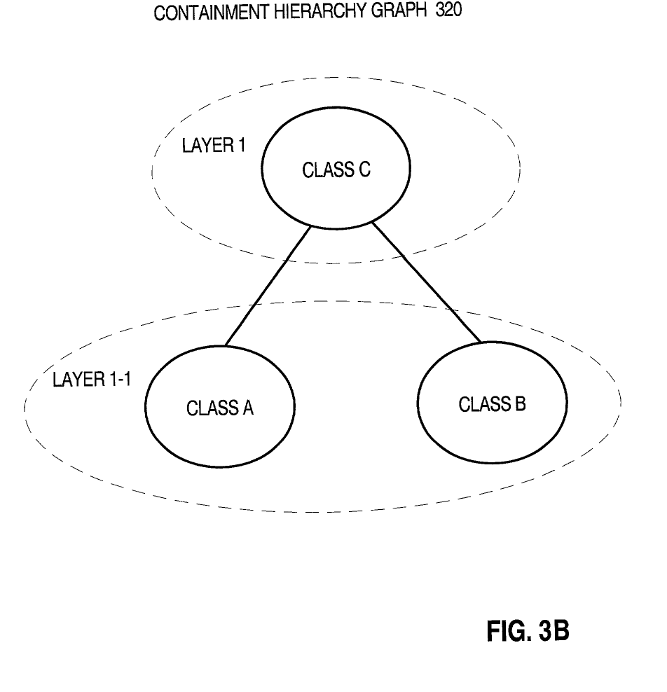

Containment hierarchy graph 310 in FIG. 3A depicts the containment relationship for the above scenario. In particular, containment hierarchy graph 310 shows that classes A and B are instantiated by class C. The containment relationship between A and B is established by registering an event handler for B, enabling interaction between class A and class B to which class C is oblivious.

Example Code of Layered Object Oriented Programming Approach:

An alternative layered object oriented programming way of achieving the same effect of inter-connecting classes A & B is to do the following.

Class C implements event1interface{

C(){
A myVarA = new A();
B myVarB = new B();
// Interconnect A & C by making the event from A to be delivered to C
myVarA.addEvent1Handler(this);
//Interconnect C & B by making the event from A to be routed from
C to B addEvent1Handler(myVarB);
}
Event1InterfaceMethod(){

// Do any work that can be done on all the classes that are
instantiated by C
// before delivering or forwarding the event to all the target
classes

.
.
.

PropogateEvent1OnToAddedEventHandlers();

.
.

}
//Delivers Event1();
AddEvent1Handler();

}

Containment hierarchy graph 320 in FIG. 3B depicts the containment relationship between classes A, B, and C achieved through the layered approach for event routing.

The Distinction Between Layered Integration of Classes & Unlayered Integration of Classes Illustrated in the Above Example is as Follows:

The distinction between the two methods in which the classes A & B are interconnected is in the way in which the event sources and receivers are linked. In the unlayered program, the two classes that are instantiated as objects by the object C communicate with each other without the knowledge of the object that instantiated.

In the layered object oriented program the events are explicitly routed through the object that instantiated the descendant objects rather than providing a reference to the descendant object to directly listen to its events.

While it may seem like this is additional work programmatically and have some performance penalties, it simplifies the containment hierarchy of instantiated objects and provides for a simpler abstraction to comprehend classes constructed using other classes that are instantiated as objects.

Containment Hierarchy of Instantiated Objects:

The containment hierarchy of instantiated objects of object A is defined as the sub-graph of all the objects that A instantiates as the vertices and the interconnects that are joined by events and event-handlers between objects that have been interconnected as the edges between the vertices.

If an object M instantiates objects P, Q and R and another object N instantiates objects M, W and X, the possible interconnects by the way events are routed and interconnected with event handlers the following schematics are possible.

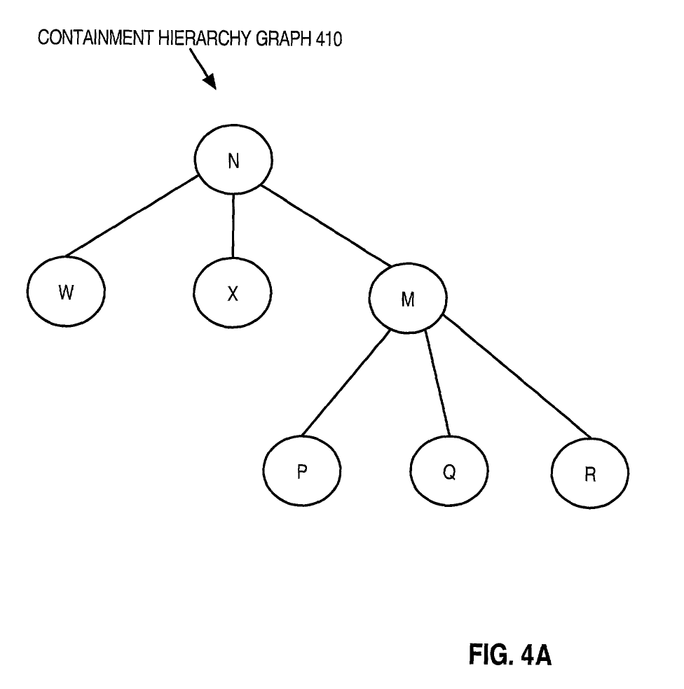

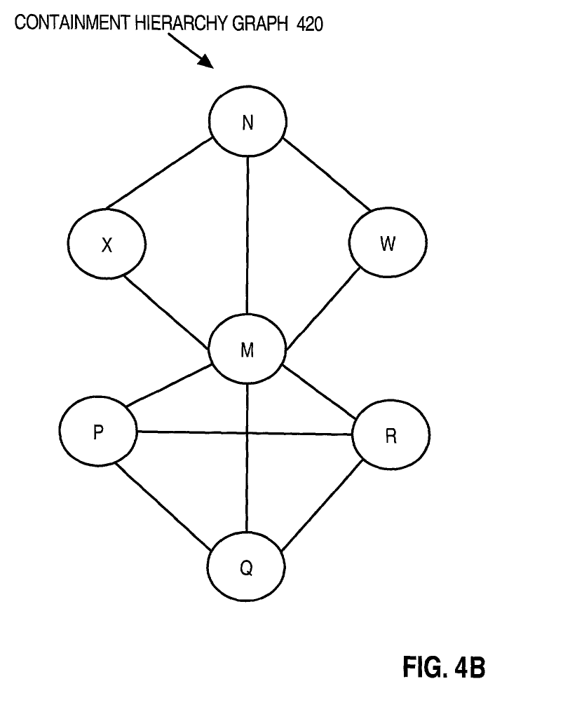

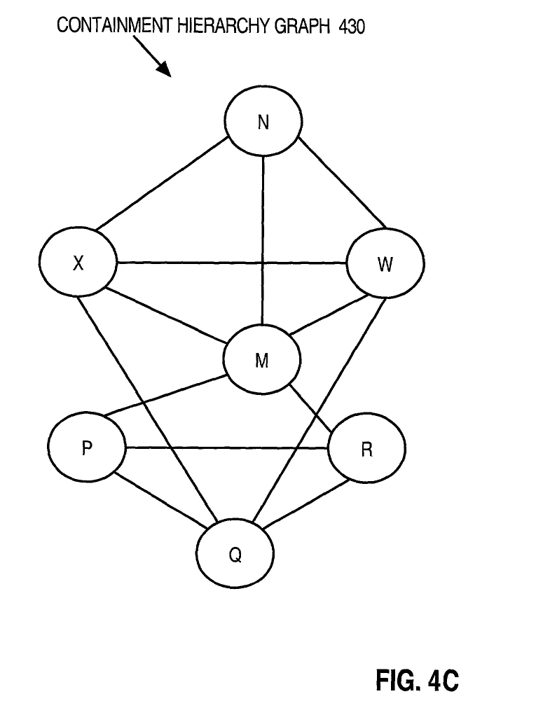

In a layered object oriented programming, the containment hierarchy sub-graph for the above objects resembles containment hierarchy graph 410 shown in FIG. 4A.

In unlayered object oriented programming, the containment hierarchy sub-graph for the above objects may resemble the containment hierarchy graph 420 shown in FIG. 4B.

One of the consequences of unlayered object oriented programming that permits interconnecting instantiated objects without the mediation of the instantiating object is that the complexity of the semantics of objects built using other objects is increased manifold in event driven programming. This increased complexity makes it more difficult for the developers of applications and objects using complex objects.

Semantics of Layering Objects in Object Oriented Programming:

Returning Internal Reference C by Object B vs Returning Copies of Instantiated Objects by Object B or Object B Providing Methods that Operate on Object C:

For purposes of illustration, there are three objects A, B and C that are used in a program. Object C is instantiated by object B, and object B is instantiated by object A. Furthermore, object B is either a member of the class A or used locally and object A is not derived from object B. The relationship between objects B & C is the same.

In object oriented programming it is permissible for an object B that instantiates another object C, to return a reference of object C to the object that instantiates B. That is object A instantiates object B, and object B instantiates object C. It is quite legitimate for object B to return a reference of object C when one of the methods of object B are invoked by A. The object C defines the state of the object B if it is a member of the class B.

Returning the Internal Reference to Object C by Object B:

If an object B returns a reference to an object C that it has instantiated, and is dependent on the state of the object C to define its own object B's state, then making a reference available will make it possible for other objects (the one's that obtain the reference) to alter B's state. In other words, effectively object B is providing an interface for the object that obtains a reference to object B to change its state by retrieving the reference to the object C. If object B needs to be cognizant of the changes happening to its state then the additional code that has to be written to trigger the actions in object B based on modifications made to object C are non-trivial and often times complicated.

A way to avoid the predicament of complicated code to be written to track changes in object state, one has to restrict what the obtainers of an internal reference can and cannot do. One of the simple restrictions is for object B to not return any references to objects that represent internal state of object B unless it is absolutely necessary. If this restriction is placed, then what are the plausible alternatives for object B to manipulate objects C. Well, one could construct methods for class B that manipulate the object C's methods. This will ensure that object B does not have to do additional programming to track changes to the references of object C as they will all vector through the code executed by object B.

Another approach is to not pass the reference of an object C that defines the state of object B. Instead a copy or a clone of the object is returned for the holders of reference B to use and if the changes to the copy of C need to be reflected in B, a special interface should be supplied by B. This modification ensures that object B will always invoke its code that makes changes to its state.

Another problem with exposing references to state defining internal objects is the additional interconnections that become possible. As an illustration, the scenario involving the objects P, Q, R, M, N, W, X described in the subsection of containment hierarchy is used. If reference to Q is passed by M to N, then the interconnection diagram is further cluttered with additional links making the analysis of a software module N with such an interconnection diagram even more complicated, as shown by containment hierarchy graph 430 in FIG. 4C.

The Constraint Placed on Internal References in Layered Object Oriented Programming:

1. Avoid returning references to internal objects, as that might alter the state of the object supplying references to the internal objects

2. A reference of an object propagated up the containment hierarchy should not be used to modify internal states of returning objects (i.e the methods of the references should not be invoked) within a layer of execution (to be defined below).

The above two constraints ensure that multiple containment is minimized to the desired extent & keeps the programming model reasonably simple and layered object oriented.

When Objects are Extended or Derived from Base Classes:

When new classes are created by deriving from already implemented base classes, the containment hierarchy that is imposed by the derivation semantics ensures that the new classes do not create situations that lead up to undesirable multiple containment and thus the programming model remains to be layered object oriented program.

Considering it is possible for combining the derivation from base classes with the usage of internal classes to use already implemented classes. In such scenarios, the above described constraints for internal classes apply the same way they applied for classes that were built without deriving from any base class but solely using existing classes as internal class members.

To Re-iterate Layered Object Oriented Programming is Defined by the Following Constraints:

In classes created using pre-implemented classes as internal member classes:

In the layered object oriented program the events are explicitly routed through the object that instantiated the descendant objects rather than providing a reference to the descendant object to directly listen to its events.

Avoid returning references to internal objects, as that might alter the state of the object supplying references to the internal objects.

A reference of an object propagated up the containment hierarchy should not be used to modify internal states of returning objects (i.e the methods of the references should not be invoked) within a layer of execution (to be defined below). In other words multiple containment of an object is permitted only if the two containing objects do not belong to the same plane of execution.

In classes created using pre-implemented classes by deriving from the pre-implemented classes:

There are no explicit constraints for new classes that only derive from existing classes without any existing classes used as internal members of the new class created.

Adhere to all of the above constraints in scenarios that involve new classes that both derive from existing classes and use existing classes as internal members of the new class created.

Implementation:

One can easily think of implementing a source code analyzer that can check if a particular application is a layered object oriented program.

Implementable: Source code analyzer that checks if a given set of source files combine to form a layered object oriented program.

Objects Executing in Multiple Planes of Execution:

A Single Plane of Execution of Layered Objects:

In layered object oriented programming that does not permit multiple containment at all, the containment hierarchy of any application can be represented by a tree, where the nodes in the tree are the objects instantiated and the links between the object or the edges between two nodes in successive levels of the tree determine the instantiating order of the objects. As the containment relationship can exist only between an instantiating and the instantiated objects in layered object oriented programs, there will not be any other edges besides the edges created by the instantiating order.

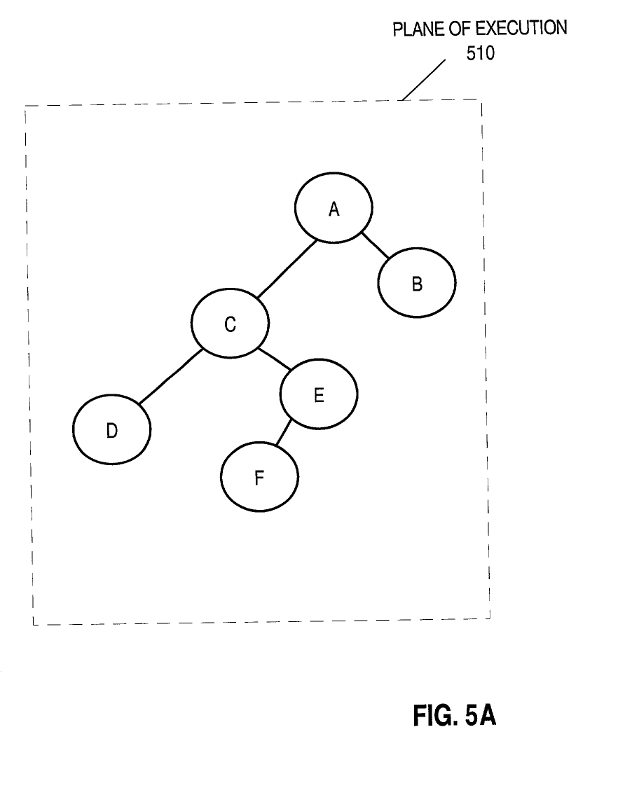

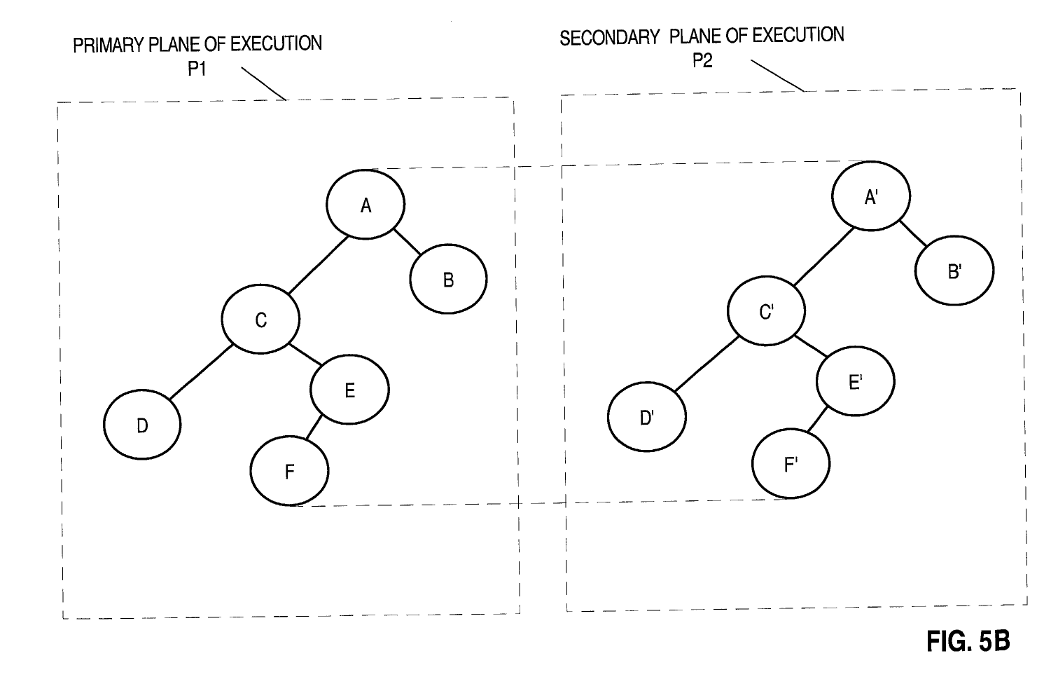

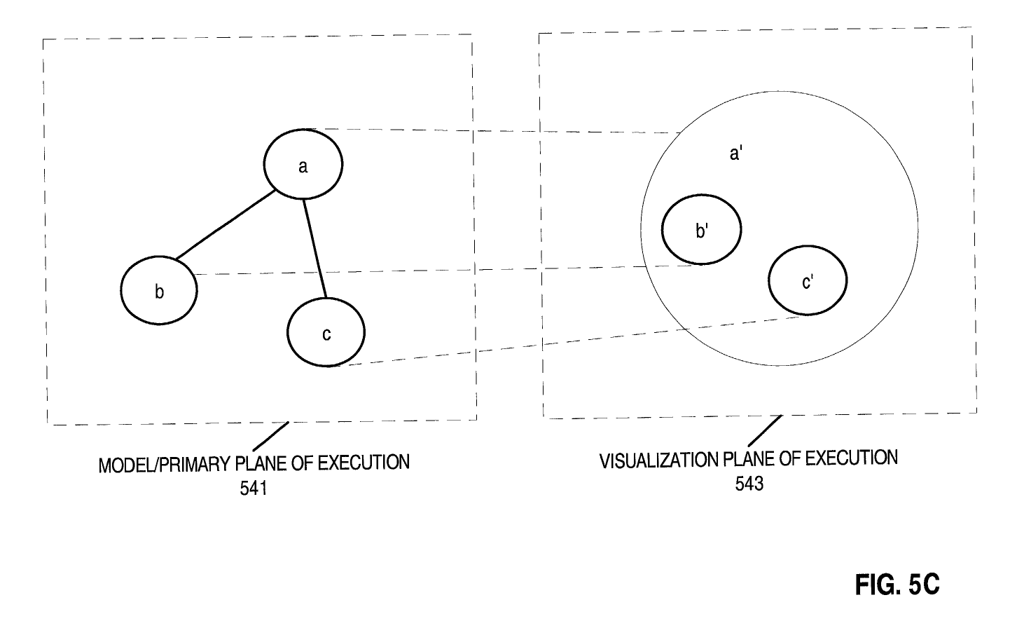

A sub-graph of a containment hierarchy graph of a layered object oriented application that does not have any object that is multiply contained is said to represent a plane of execution of layered objects. FIG. 5A depicts plane of execution 510, depicting a containment relationship without multiple containment between objects a, b, c, d, e, and f.

If multiple planes of execution exist in a given application, then one of the planes of execution can be tagged the primary plane of execution.

Any application that is implemented as a layered object oriented application with the constraints specified for layered object oriented program will contain at-least one plane of execution of layered objects. This is due to the fact that by definition multiple containment is avoided between objects that belong to a single plane of execution.

In real programming that conceives of all data as amenable to the model viewer controller abstraction, there may be a plane of execution of all model objects that are instantiated in an application. This is due to the fact that an application that adheres to layered object oriented programming that can be created using just the objects that represent the model data without ever having to visualize the models that are used in the application. Considering layered object oriented applications built using MVC architecture will certainly require a plane of execution of layered objects, the plane of execution containing the model objects is designated as the primary plane of execution. In fact, as described later, all significant model objects can be part of the same plane of execution.

Parallel Planes of Execution of Layered Objects or Secondary Plane of Execution of Layered Objects:

FIG. 5B shows parallel plans of execution in an application X. Application X has a designated primary plane of execution of layered objects, and this plane of execution is denoted by P1. Furthermore, there is another plane P2 of execution of layered objects in the same application. For every object (called primary object) in the primary plane P1 of execution, there exists a corresponding reflection object of execution in P2. In P1, objects a, b, c, d, e, and f correspond to objects a′, b′, c′, e′, and f′ in plane P2. Also, the containment hierarchy graph of layered objects in the plane P1 is identical to the containment hierarchy graph of objects in P2. In such a scenario, the plane P1 & P2 are said to be parallel planes of execution of layered objects.

All the parallel planes of execution that are not the primary plane of execution of layered objects are called the secondary planes of execution.

Rules of Containment Hierarchy and the Constraints for Layered Object Oriented Program for Objects in Secondary Planes of Execution:

1. The reflection objects in the secondary planes of execution can be instantiated by the corresponding primary object in the primary plane of execution.

2. The methods and the events of the secondary object can be operated on by the primary object. The converse of the secondary object being able to manipulate methods of the primary object and listen to the events of the primary object is also permitted.

3. In the secondary plane of execution, the containment relationship between objects is determined by the containment relationship between the corresponding primary objects in the primary plane of execution.

4. A reference of a secondary object f′ can be returned by the corresponding primary object f to the parent of the primary object f (i.e e) so that e can supply the reference of f′ to e′ so that e′ can establish the containment hierarchy relationship in a secondary plane.

Primary and Model Plane of Executing Objects & Secondary and Visualization Plane of Executing Objects:

In MVC architecture where the model is abstracted separately from the visualization elements and the control elements of the model, the layered object oriented programming with multiple planes of execution provides an attractive paradigm to build new visualizable models from existing implementations of models along with the visualizers and controllers.

In order to facilitate this, model objects are instantiated and used in the primary plane of execution. The corresponding visualization objects are used in the secondary plane of execution called the visualization plane of execution.

A new model object can be created in such a way that it uses existing model objects as elements of the new model object. The containment hierarchy discipline imposed by the layered object oriented programming ensures that the model objects in the primary plane of execution will resemble the containment hierarchy that is necessary to describe a meaningful containment strategy for visual objects.

A description of the sequence of instantiation is illustrated using the planes of execution shown in FIG. 5C.

Two MVC architecture elements are implemented as model objects b, c and visualization and control objects b′ and c′. A new model a is being constructed using two existing model objects b and c in such a way that the visualization of the combined model will visually contain the two visualization elements of b & c.

The creator of the model, visualization and control elements a and a′ will instantiate b & c in the model/primary plane of execution 541.

Programmatically, for this scheme to work it should be possible for the object {a} through an interface to invoke the instantiation of b′ & c′ in the visualization plane of execution 543 (this visualization object instantiation interface is implemented by b & c or for that matter any containable model object that has a visualization reflection object). Note that containment relationships for visualization plane of execution 543 are depicted in a different way. Rather than using an edge between vertices that correspond to containing object a′ and contained object b′, a graphic for contained object b′ is depicted within the graphic for the containing object a′.

The object a also instantiates the reflection object a′ in the visualization plane of execution 543. The implementation for a′ chosen for the object a should visually be capable of containing the visual objects b′ & c′ and managing the objects using some layout manager that helps format the layout of b′ & c′.

After the object {a} instantiates b & c, {a} invokes the methods of b & c that instantiate b′ & c′ and obtains the references from b & c. Object {a} without using these references passes the references to a′ and requests a′ to manage the visual objects b′ & c′.

The Coupling of Objects in the Primary/Model Plane of Execution & the Reflection Objects in the Visual Plane of Execution:

This sub-section enumerates the interactions between a primary model object in the primary/model plane of execution and the corresponding reflection object in the secondary visualization plane of execution.

1. The reflection object of execution is instantiable by the primary/model object using a method of the primary/model object for instantiating the reflection object.

2. The constructor of the reflection object can take a reference of the primary/model object to help the reflection object listen to the events generated by the primary/model object in the construction phase.

3. The reflection object will keep the reference of the primary model object to be able to directly invoke the methods exposed by the primary object.

4. Similarly, on instantiating the reflection object the primary/model object uses the reference to the reflection object to bind appropriate event handlers to the events generated by the primary/model object.

5. The primary/model object also uses the reference to the reflection object to modify the behavior of the reflection object.

The act of instantiation and mutual binding of events with event-handlers by both the instantiating and the instantiated objects is called the coupling of objects. The above set of steps describe a coupling relationship between a primary/model object and its reflection object in a visual plane of execution.

A similar coupling can take place between other objects that participate in layered object oriented programming.

In a given primary plane of execution, the object coupling can take place between two objects, where one of the objects is instantiated and the other object is instantiating. The object coupling is permissible between a primary/model object and a reflection object in a secondary plane. In secondary planes of execution, object coupling is allowed between those objects whose corresponding primary objects have a permissible coupling relationship.

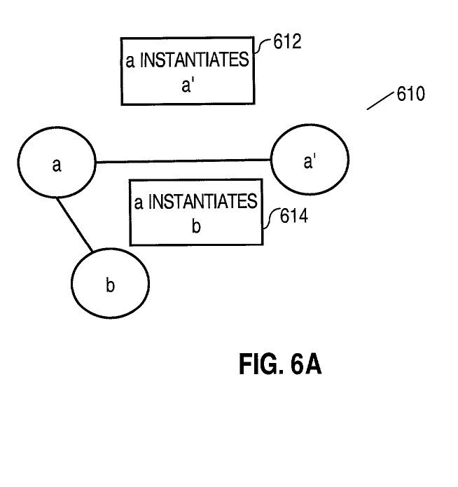

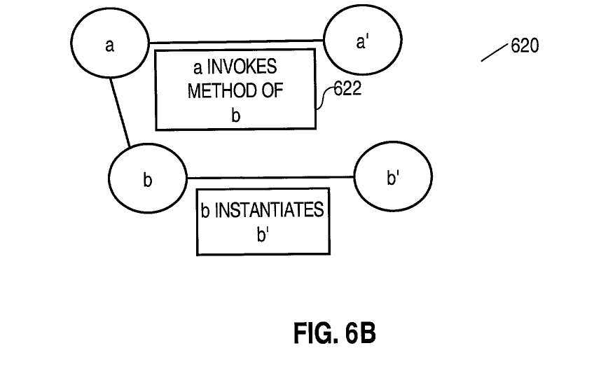

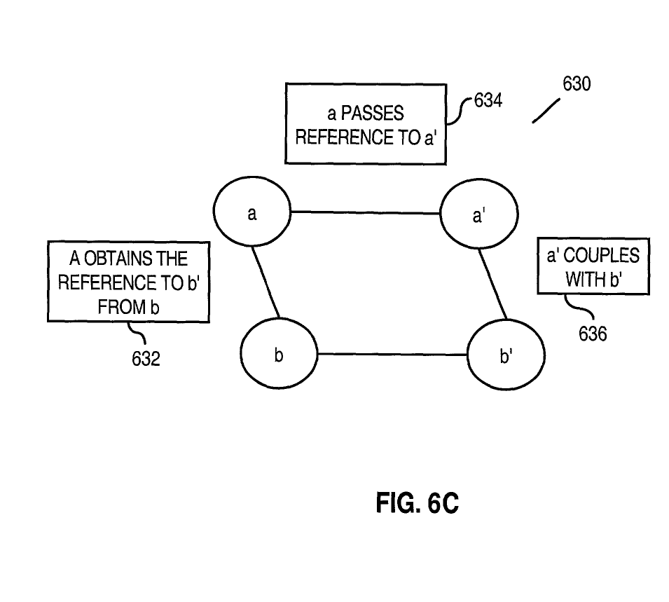

FIGS. 6A, 6B, and 6C depict a sequence of instantiation and coupling that happens between two MVC elements, each described by a model/primary object in the primary plane of execution and a corresponding reflection object in the visual/secondary plane of execution. FIGS. 6A, 6B, and 6C include containment relationship graphs 610, 620, and 630, which depict containment relationships at various stages of the sequence. FIGS. 6A, 6B, and 6C also show the steps of the sequence, as follows.

At step 612, model object a instantiates visual object a′.

At step 614, a instantiates model object b.

At step 622, a invokes a method of b to cause b to instantiate visual object b′.

At step 624, b instantiates b′.

At step 632, a obtains a reference to b′ from b.

At step 634, a passes the reference to a′.

At step 636, a′ couples with b′.

The parent of b, in this case a determines if a′ is visualized or not. A′ manages the visual containment of b′ using a layout manager that is selected by a for a′. In principle, a may chose to use b as model/primary object like object without ever visualizing the model. The mandatory interfaces that are to be implemented by the model/primary object (or classes that model/primary objects are derived from) help supply the methods involved in the invocation of visualizable reflection objects.

The mandatory interfaces that are to be implemented by the visualizable reflection objects (or the classes that reflection objects are derived from) help supply the methods involved in facilitating containment management of the visually contained object.

Some methods that are universally required to be implemented to facilitate the interactions between the primary/model object and the corresponding visualization/reflection object are mandated to be implemented by the primary/model object and reflection object.

Some of the interconnections between the primary/model object and the visualization/reflection object are defined by the interfaces that are specific to the particular model and the visual rendering of the object.

The reflection object that is visualizable may contain some visual elements that are considered to provide the control function in the MVC architecture. Depending on the specific application that is being created, it should be feasible to display or not display the control elements of the visualization. The mandatory interfaces implemented by the primary/model object and the corresponding reflection object should make it possible for displaying the visualization of the model without displaying the control visual elements of the model.

Note: The model objects should be usable as regular objects without the instantiation of the reflection/visualization object and this should not in any way affect in adversely the behavior of the application that is created.

Implementables:

Define the following interfaces:

Coupling interfaces

Interfaces that help instantiate the contained objects & the reflection objects

Describing guidelines for the interactions between coupled objects in the visual plane of execution

Guidelines for the interactions between the parent and child in the primary/model plane of execution

Dealing With Instantiated Objects that Crash:

One of the outcomes of instantiating objects used by an application as a distributed object instead of a local object is that the instantiating object and instantiated objects do not both belong to the same process (as in UNIX process). This in turn implies that some objects in an application may crash while the others may still be alive. This scenario does not have an equivalent in non-instantiable distributed object scenario, where all the objects instantiated belong to a single process.

The recommended way to deal with this scenario is for the object higher in the hierarchy to deal with the exceptions that the distributed object subsystem throws when a stale server handle is used to invoke methods of a distributed object. The orphaned children on the other hand are to be cleaned up, and this requires the orphaned objects to detect the aliveness of their parents periodically. The base object class of all instantiable distributed objects implements the code that is used for this purpose.

Implementable:

Interfaces that allow detection of aliveness of parents.

Base class implementation that periodically tests the aliveness of their parents to clean up if they get orphaned.

Layered Object Oriented Programming's Contribution in Facilitating Multi-plane Object Execution:

In the absence of layered object oriented programming, creating a multi-plane execution of objects will lead to several problems besides the complexity of unlayered spaghetti linkages of objects coordinated in coherent manner across planes of execution. Without the tree like containment hierarchy of objects, it is difficult to come up with a systematic strategy that will lead to a good visual containment solution that mirrors the containment in the model plane of execution. The tree like hierarchy provides the natural containment of layering visual elements on a plane. It is for this reason, the layered object oriented programming is essential to the internet widget semantics.

Definition of an Internet Widget:

At this stage, concepts needed to define an internet widget have been developed. An internet widget is a pair of primary/model object & the corresponding secondary/visualization reflection object, where the two objects are implemented as instantiable distributed objects. The two planes of execution use the same namespace (a distributed name service) that is accessible to all the instantiable distributed objects in both the planes of execution. Internet widgets are not limited to use on network architectures that include the internet; they may be used on any network system capable of supporting distributed objects.

Infrastructure Support of Internet Widgets:

In order to be able to implement the internet widgets, the infrastructure has to address the following infrastructure problems.

The Name-collision Problem:

In traditional programming it is possible to use the same name for different variables in different parts of an application. The collisions in names used for variables are resolved using the scoping rules of a programming language. Even in traditional programming languages, one cannot use the same name for two variables within a portion of the code that is delimited by a block delimiters such as { }.

To use instantiable distributed objects within a module of a program, one needs to register the name of the newly instantiated distributed object in the same namespace that is shared by several IDOs that are part of the various internet widgets used in an application. To highlight the problem, the interface for instantiating an IDO is re-iterated.

Class DOInstantiator {
InstantiableDO instantiate(IDOClassName, IDOObjectName, LPO, scheduler, namespace,

IDOClassImplementationDefaultLocationPathName);

InstantiableDO instantiate(IDOClassName, IDOObjectName, LPO, hostname, namespace,

IDOClassImplementationDefaultLocationPathName);

InstantiableDO instantiate(IDOClassName, IDOClassImplementationPathName,

IDOObjectName, LPO, scheduler, namespace,
IDOClassImplementationDefaultLocationPathName);

InstantiableDO instantiate(IDOClassName,

IDOClassImplementationPathName,IDOObjectName, LPO, hostname, namespace,
IDOClassImplementationDefaultLocationPathName);

}

As it is easy for one to observe the usage of the same variable name within the scope of the block delimiters, one does not need any special conventions to avoid name-collision. However, the IDOs instantiated in various modules at various junctures in the program workflow are harder to track to ensure that the same name is not used in the namespace by two different modules in instantiating two different IDOs. Since different internet-widgets may be developed by different development teams, it is that much harder to guarantee that some internet-widget has not used the name that the user of the internet-widget also wants to use as the source code for the internet-widget being used is not necessarily open. To avoid name collision across IDOs that are part of internet-widgets used in applications, a convention is needed that ensures that name collision does not take place within a name space.

The Naming Convention for IDOs to Avoid Name Collision in Applications Using Internet Widgets:

Assumptions:

1. The application launch will supply the name service that provides the application namespace to be used by an application and only the application.

2. Plausibly, the application launch will spawn a new nameserver or use an existing nameserver whose contact information is made available to the application at launch time.

3. Similarly a global nameserver that provides a global namespace used by several applications is also supplied to the application at launch time, or implicitly made available by the distributed object middleware that an application connects to on the host where the entry class (that contains the main entry point) of the application is spawned.

4. There will be a single primitive class that is the base class of all the objects that are created as IDOs belonging to internet-widgets.

Convention1:

Unlike in regular programming languages, a different program boundary applies for using the same name for IDOObjectName. Instead of the traditional boundary of a block, programming using internet-widgets requires that the same name cannot be used for the IDOObjectName for various instantiations of any IDO in a given internet widget.

Convention2:

Each object in an execution plane of an application has a local name tag that is the equivalent of the variable name used in traditional programs for local objects. However this local name tag in itself is not used as the IDOObjectName. The fully qualified name is derived by appending the local name tag to the name tag that is composed by the name tags of all the objects in the containment tree between the root and the object that is instantiating the object with local name tag. The characters are recommended to be inserted between the local name tags of various objects in the fully qualified name for readability purposes, when one instantiates an IDO and composes the name of the IDOObjectName by adding GetTheRootToNodeFullyQualifiedNameTag( )+_“uniqueLocalNameTag”.

The primitive class that is used to derive every IDO used in each internet widget implements the following methods with the semantics described below.

GetTheRootToNodeFullyQualifiedNameTag( );

SetTheRootToNodeFullyQualifiedNameTag( );

At the time of instantiation of IDO A, the SetTheRootToNodeFullyQualifiedNameTag( ) method is invoked by the instantiated method so that during the life of the IDO A belonging to an internet widget, the GetTheRootToNodeFullyQualifiedNameTag( ) can be used for instantiating every other IDO during the life of this IDO A.

Implementable:

The base class that all the IDOs are derived from and defining the methods that are necessary at the interface level for an internet widget to deal with the name collision problem with instantiating resources that have a scope of usage outside the executing application that instantiates them.

Instantiating Internet Widgets:

Instantiating an internet widget as an entity is done by the primary/model object of the parent of the internet widget. The primary/model object that is implemented in the primary plane of execution is instantiated and based on the intent of the parent internet widget the reflection object in the secondary visualization plane is either rendered in the reflection object of the parent widget or not.

Destruction of Internet Widgets:

In traditional local objects, the object goes out of scope outside the boundaries of scope delimiters. Since instantiable distributed object scope is not delimited by the scope of the IDO (it can be if the language definition can be modified) the objects that are not needed have to be explicitly destroyed by the internet widget that instantiates them.

There may be a need for a keep-alive based destruction strategy that self destroys objects if the parent object is not reachable beyond a point.

This keep-alive strategy will prevent IDO leaks.

Implementables:

A method in the base IDO class to destroy an IDO.

Keep-alive based self destruction code for the base IDO class.

Garbage Collection of Internet Widgets:

A garbage collection mechanism can be envisioned to clean up unnecessary IDOs that are not referenced by any of the objects in an application by devising a reference counting heuristic. The semantics of this need to be devised over a course of time as the obtainer of the reference or the object that passes a reference to another object has to increment the number of references and this needs to happen under the hood without burdening the developer.

Deriving Internet Widgets from Base Internet Widgets:

In order to develop internet widgets, the developer has the choice of using other internet widgets as base internet widgets, or derive the model class and visualization classes from independently developed IDOs or not derive the model classes with any available IDOs. When the developer chooses to derive internet widgets from other base internet widgets, the onus is on the developer to ensure that the derived model and visualization objects build on the coupling semantics already built by the base internet widget. This is not a concern if the model and visualization objects or derived using base IDOs that are not coupled as internet widgets.

Design of Practical Internet Widgets:

Physical Services:

A discussion on a class of traditional network services has been deferred in order to simplify the discussion in developing the concepts necessary for describing internet widgets. Often times it is not feasible to instantiate a separate distributed object that is accessible just to a single application for every application that is being executed either on a single host or a collection of hosts in a network. Some of the classes of distributed objects that cannot be instantiated separately for each application are:

1. Physical devices that are available over a network as a service.

2. The data operated on by the distributed object is to be used by several applications.

1. Physical Devices:

Conceptually every physical device can be thought of as a device that is available as a network device. A printer, disk drive, a microwave, refrigerator or any device for that matter can be abstracted into a software object. Such devices are typically used by more than one user/application. In traditional operating systems on computers that support multiple applications and multiple users, the peripheral devices that are connected to the computer may be used by several applications and users to the extent they can be shared. An example of the above scenario is one where a printer needs to be exclusively used by one application attempting to print something, and should not be accessible to any other application until the print job is completed. These types of constraints in the usage of the devices are enforced by the device interfaces that the operating system makes possible for applications to use. To all the applications that are being executed by the operating system, it would seem like they have exclusive access to the devices that they use.

When the physical devices are turned into networked devices that have the capacity to instantiate distributed objects it is possible to instantiate a distributed object that implements the interface necessary to operate the physical device. However it is not feasible to allow every application to instantiate an IDO for the physical device any time an application needs to use the device.

2. The Data Operated on by the Distributed Object is to be Used by Several Applications:

IDO abstraction and the internet widget abstractions without any modifications are inadequate as demonstrated in the “Physical Devices” section. As with the physical devices, some persistent data can be modeled the same way physical devices are abstracted for usage. This subsection explores the scenarios in which persistent data cannot be used with the IDO, internet widget abstractions. Data that requires a software module to ensure consistent access to the data is referred to as data needing consistent access or as DCA.

The scenarios in which generic persistent data and physical devices will require an alternate model that is different from the IDO abstraction have a lot of commonality. It is not uncommon for some data to be used simultaneously by multiple applications. Several data repositories contain data elements that are usable by multiple users and multiple applications. From data contained in ordinary files to data bases typically is shared by multiple user. If the data element that is to be shared is a persistent storage representation of an object (a distributed object in particular), then conceptually an application will be able to instantiate an object using the data as described in the IDO instantiation semantics. However if this data were to be used by multiple applications, and the owner of the data may not want the multiple users of the data to change and store the data in a manner that can render the data inconsistent. To avert this possibility, one may use the following abstraction.

Virtual Services:

This subsection describes a familiar abstraction that will help resolve the problem described in the section above. For every physical device that is to be accessible as a distributed object over the network, the software elements that make it possible to be used as internet widgets in applications are described in the section.

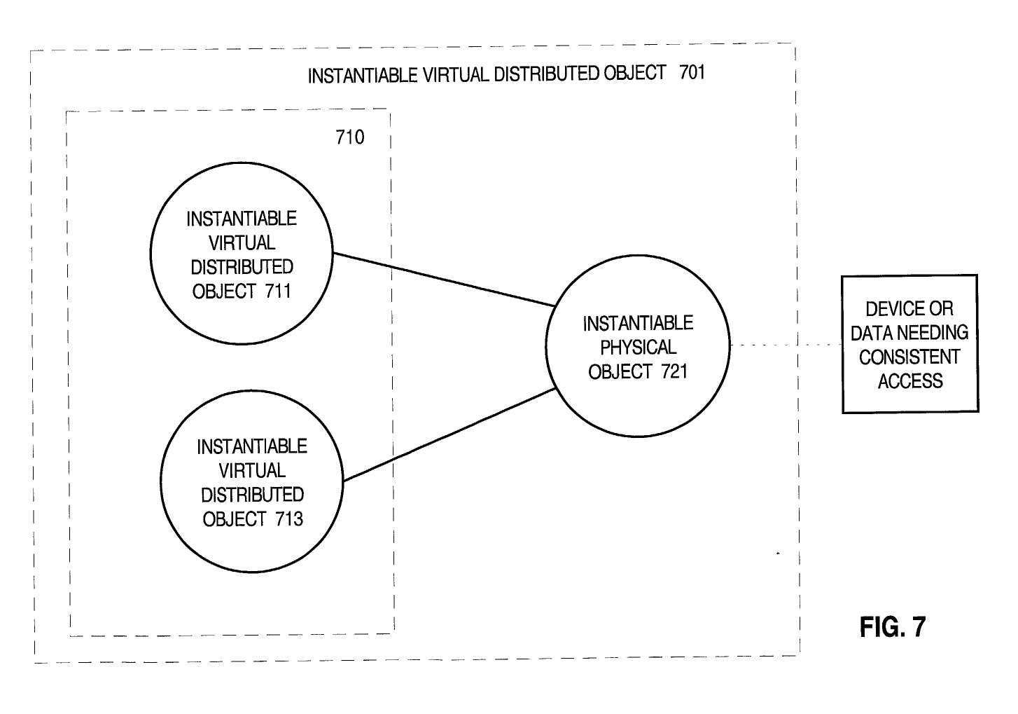

FIG. 7 shows how the instantiable distributed object 701 may be partitioned into two elements. The instantiable physical distributed object 721 (IPDO) and the instantiable virtual distributed objects 710 (IVDO) are the two elements that the instantiable distributed object is partitioned into. An IPDO can be instantiated only once per physical device/data that it models. It is either instantiated by an application that is the first user of the physical device/data, or have it instantiated as part of a start up sequence for the device/data. An IVDO on the other hand can be instantiated just the way any generic instantiable distributed object can be instantiated. In other words, there can be several IVDO's instantiated per any single physical device (or DCA) and its corresponding IPDO.

The coupling between a given IPDO & an IVDO is defined and implemented by the software developer that is designing a software interface for the specific device or data. Now, in order to make it possible for multiple devices of similar kind (say printers) to share the same software elements, and for applications to use similar interfaces to operate these devices the interfaces and the events that facilitate the coupling between the IPDO and IVDOs and the interfaces and events of an IVDO that are used by the instantiating objects have to be standardized.

A brief example is provided to show how an IVDO and the IPDO together make it possible for an application to instantiate one or more IVDO's for the same IPDO.

1. The IPDO is either launched on request by the device at startup or it is launched when an IVDO is instantiated for the first time for that specific IPDO.

2. As the IPDO is instantiated, its name and connection information are registered with the global name space.

3. The IPDO implements methods and events that do not assume that only one application will invoke these methods and listen to its events.

4. If a specific IVDO needs to be contacted for some information within a single method of IPDO invoked by an IVDO, the method expects the reference to the IVDO supplied in every invocation. (to implement asynchronous communication) The same strategy is used to have the IPDO target events to a specific IVDO. The IVDO will register an event handler and pass to the IPDO the information necessary for the IPDO to deliver the event to the correct IPDO.

5. The IPDO will not keep any state beyond a single method (this restriction is a guideline to simplify the programming model). If the implementor of IPDO and the corresponding IVDO extend to implementing a registration scheme that allows IPDO to lookup the references of IVDOs and the event receptors of the IVDOs across different methods of an IPDO.

6. The object instantiating the IVDO will indicate to the IVDO to bind to the specific IPDO if it can, otherwise the IVDO will attempt to find a reference to the IPDO that corresponds to the IVDO from the global name space that implements the interface shared by the IPDO and IVDO.

7. The persistent objects of the serialized IVDO will contain the information necessary to establish a connection between the IVDO and the IPDO.

8. The relationship between the IPDO and an IVDO is more akin to the traditional relationship between a distributed object where the IPDO is the server object and the IVDO is a client to this server object.

Note: Every IPDO may have multiple IVDOs that are specific to particular set of operations that can be performed on a physical service. For instance one can imagine a run-time IVDO and administrative IVDO where each are used in different types of applications. Similarly, a database IPDO may have several IVDOs tailored for various operations that are different in nature.

Finding Virtual Services:

For an IVDO to discover the IPDO, the IVDO needs a method to search the namespace to identify all the valid physical devices that an IVDO can bind to. The constructor of an IVDO should be provided with a utility class that can help identify in a given namespace all the IPDOs that implement the interface that IVDO needs to interoperate with an IPDO.

Definition of a Virtual Service Internet Widgets:

While the abstractions of instantiable physical distributed objects and the instantiable virtual distributed objects help several applications use a service offered by a single device and services that need to preserve the consistency of data (DCA data) operated on by several applications, it can be further improved to make it simpler for application developers to develop applications that use these services. As described in earlier sections, an internet widget makes it possible for the developer of a software to operate on a data object by not only providing the functionality that lets application developers to use in their applications, but also the viewable visualization and control elements appropriate for operating on the data object so that the application developer does not have to re-implement the UI elements of an object. To allow developers of objects that operate on devices and data that need to be simultaneously accessed from multiple applications to provide the same convenience, a new abstraction called the virtual service internet widget is introduced.

A virtual service internet widget is the pair of an IVDO (associated with an IPDO) that is to be used as a primary/model object in the primary plane of execution of an application and a corresponding reflection object in a secondary visualization plane of execution. The two planes of execution use the same namespace (a distributed name service) that is accessible to all the instantiable distributed objects in both the planes of execution. In the rest of this document, internet widgets that are not virtual service internet widgets are referred to as simple internet widgets to distinguish each other.

Where are IPDO, IVDO & the Reflection Object of the Virtual Service Internet Widget Executed?:

The IPDO executes on a processor bound to the physical device. Or in the case of data needing consistent access (DCA data) the startup sequence for the IPDO for the DCA data.

As the IPDO can be instantiated either by the application that first needs access to the data bound to the IPDO or a startup sequence managed by the administrator of the data. The IVDO primary object executes where the scheduler of the instantiate methods schedule the IVDO to be executed, and typically these are a set of computers the user has access to.

The reflection object of the IVDO belonging to the secondary plane of execution is executed on a computer that is bound to the display the user is using to see the user interface.

Some Salient Features of IVDOs in Virtual Service Internet Widget:

1. The IVDO's in memory state can make it possible for stateful usage of devices even when the IPDO's themselves are implemented as stateless.

2. The virtual service internet widget's IVDO's serialized and stored persistent object can keep state information pertaining to the application context in which a service internet widget is being used, thus making it possible for creating state that spans multiple sessions of using a device.

With the implementation of virtual service internet widgets for all physical devices and data that needs consistent access, integrating devices and persistent data with applications will become quite easy, as illustrated below.

Smartcard Authentication Device

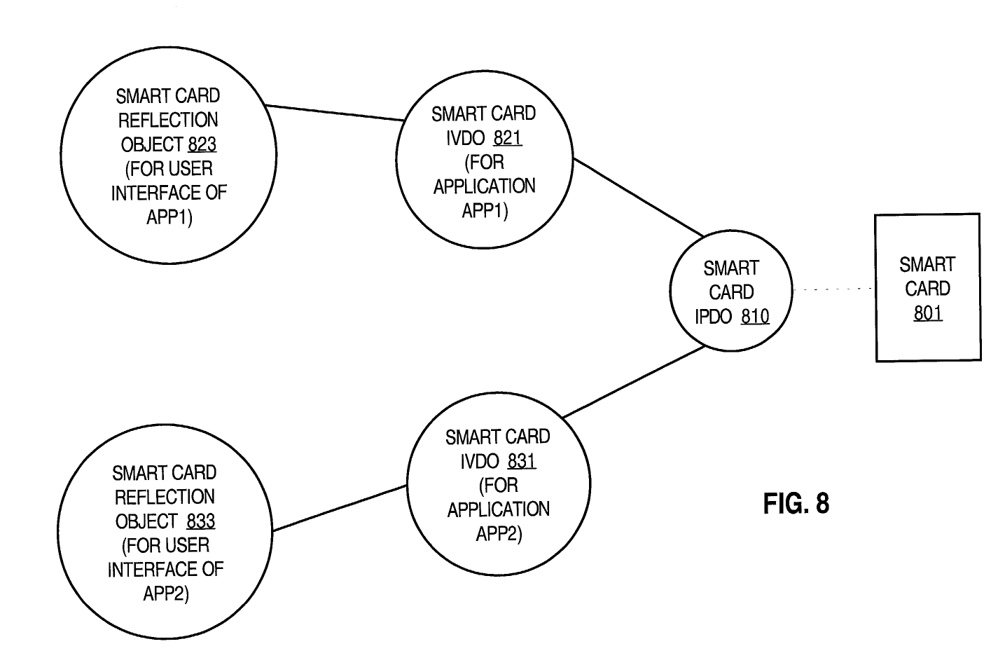

For purposes of illustration, an application app1 periodically requests the user to authenticate using a password supplied by the user. The application authenticates the user using a username and password obtained through a smartcard device. The primary/model object of this application can be programmed to interconnect virtual service internet widgets shown in FIG. 8.

Referring to FIG. 8, it depicts Smartcard IVDO 821 (primary object), smartcard reflection object 823, and Smartcard IPDO 810, which have been implemented for smartcard device 801. [BULG97] When the user account is created with a username and password by the authentication scheme used by application app1, the primary model of the application invokes the account information storage interface for smartcard device 801 through the interface of smartcard IVDO 821. If smartcard IVDO 821 needs some information from the user to retrieve the account information, then smartcard IVDO 821 causes smartcard reflection object 823 to display a prompt to the user to obtain the information.

Subsequently, the application retrieves the username and password from the user's smartcard. Specifically, the application model object invokes the interface of the smartcard IVDO 821 that triggers authentication of a smartcard. This request in turn will force the smartcard IPDO 810 to ask the user to insert the smartcard into smartcard device 801. When the username and password is supplied, smartcard IPDO 810 gives smartcard IVDO 821 the username and the password for the user. Then smartcard IVDO 821 will supply this information to the primary object that is used for authenticating the user, allowing the application to authenticate the user using the password and username.

An application developer may implement such an authentication capability without having to develop a separate UI to interact with the user.

Another application app2 may concurrently use the smartcard device to authenticate a user. Similar to application app1, the primary/model object of app2 uses smartcard IVDO 831 and smartcard reflection object 833 to authenticate users through the smartcard device 801 as modeled by smartcard IPDO 810.

To further illustrate the advantages of programming using virtual service internet widgets, programming in the absence of virtual service internet widgets may be contrasted. Similarly, one can think of integrating tape devices, refrigerators, microwaves or any other device with software applications using the Virtual Service Internet Widgets, which provides a powerful programming model for application development for devices that are networked.

Display Device as a Virtual Service Internet Widget:

Just as easily, a display computer that executes the reflection objects belonging to the visualization plane of execution is but a display device and hence it can be designed to be implemented for programming as a virtual service internet widget. The reflection object corresponding to an IVDO for a display object can be used to programmatically change the characteristics of the display device. All the reflection objects executing in the visualization plane of execution use the IVDO of the display device to render the visual elements in the co-ordinates determined for them by the other reflection objects that contain them in the containment hierarchy. Most of such code will be implemented in convenient classes that are built on top of the IVDO for the display device. These convenient classes also use other devices such as keyboards, UI devices such as tablets and such so that the programming effort is simplified for the creators of the reflection objects. The creators of reflection objects will use more familiar abstractions of user interface such as menus, menu buttons and such. If the reflection objects in the visual execution plane in turn use internet widgets, and if all the primary/model objects are executed on computers dedicated for the execution of primary/model objects in the primary execution plane then the question of where the primary/model objects of the internet widgets invoked by the reflection objects are to be executed needs to be answered. The reflection objects that invoke internet widgets in the visualization plane of execution are to execute only those widgets that help in processing that benefits visualization functionality (the internet widgets that serve this purpose are to be identified to help the developers know what internet widgets can be used as part of the reflection objects in visualization plane). For these internet widgets, the primary/model objects will be executed on the computer that is dedicated for processing the reflection objects in the visualization plane of execution, in other words the computer connected to the display.

Also, it should be noted that the implementation of support for internet widgets does not require the availability of display devices with a virtual service internet widget for the display device. Existing UI classes, such as SWING can be used to device reflection objects that can be used by the primary model objects (It is beyond the scope of this document to describe the specifics of how SWING can be used to perform this task.).

In fact, reflection objects may be built using internet widgets that use an IVDO for providing screen printing facility of printing what is rendered on the display. This printing operation may be quite different from how the primary/model object may chose to utilize the printing device to print the model that is quite different from how the model is currently displayed on the screen.

Access Control Subsystem:

This subsection examines how the virtual service internet widget abstraction helps to program an access control subsystem. The access control subsystem allows applications to define policy for the resources created using the applications that create them and allow access to the resources in subsequent accesses to the resources by various applications. Considering any reasonable access control subsystem is used by multiple applications, the virtual service internet widget paradigm is used by the creator of the access control module. That in effect means that the access control subsystem developer creates an IPDO, IVDO primary model object and a reflection object that is to be used in the secondary visualization execution plane.

Now any application creator that wants to incorporate an access control subsystem can use the virtual service internet widget of the access control system without having to create a new user interface and the functionality necessary to administer the policy of this subsystem. During the course of verifying access permissions, if the access control subsystem needs to interact with the user for say some password or such it seamlessly does so using the reflection object associated with the access control subsystem. In other words the developer of the application does not have to create the user interface that is specific to the access control semantics. In traditional programming, the application creator invariably creates the UI for all the services in the distributed computing sense of services and it is an extra burden to understand the semantics of appropriate UI for every user of the service.

From the above two examples it should be apparent to the reader the benefits of developing internet widgets and virtual service internet widgets would tremendously improve the programming ease.

Lifecycle of Virtual Service Internet Widgets:

Instantiating Virtual Service Internet Widgets:

The virtual service internet widget is instantiated just the way internet widgets are instantiated. The only difference being the fact that the IVDO is the primary object executed in the primary plane of execution. Depending on the semantics of instantiation of the IPDO corresponding to the IVDO, the IPDO may itself be executed by the IVDO or the IPDO is expected to have registered its interface such that the IVDO can bind with one IPDO or provide a choice for the user to select the appropriate physical device that executes the IPDO.

Destruction of Virtual Service Internet Widgets:

Destruction of virtual service internet widgets are identical to the destruction of internet widgets. Here too the IPDOs corresponding to the IVDOs are not destroyed.

Garbage Collection of Virtual Service Internet Widgets:

The semantics of garbage collection of virtual service internet widgets is also similar to the garbage collection of internet widgets.

Pseudo Physical Devices:

In the previous section, physical devices have been described as those that can execute instantiable distributed objects, in particular IPDOs. However it should be noted that a generic computer that is connected to a physical device can be together converted into a physical device that can execute the IPDO pertaining to the physical device. The generic computer can have the needed software that allows for instantiating IPDOs that can use the legacy interfaces that the computer supports to interact with the actual physical device. Until devices are constructed with the capacity to run IPDOs by for instance providing support for JAVA runtime, legacy devices can be made to work with the internet widget abstraction using the pseudo physical device constructed using a generic computer and a peripheral that can be operated using existing interfaces. In fact devices such as displays, printers, scanners for the foreseeable future can be created using pseudo physical devices.

Implementables:

The documents “Synchronized Computing with Internet Widgets” [SHAN00] provides additional details for implementing infrastructure support for managing the life cycle of “Virtual Service Internet Widgets”.

Transactional Computing:

Distributed computing some times is transactional in nature. This mode of computing does not require the peer processes in the distributed transaction to be executing all the time to ensure the success of transactions. Until now our description of IPDOs and IVDOs has assumed that the IPDO and the IVDO processes are executing for the duration of the interaction between the two peers. If this restriction is not imposed between these two elements in the virtual service internet widget, then the interactions between these two elements will have to account for additional scenarios when one of the peers that is involved in the transaction ceases execution intentionally or unintentionally.

Some features that need to be supported by the peers in a virtual service internet widget are:

1. A mechanism to support the communication between IPDOs and IVDOs that are different processes during the duration of the transaction.

In effect, if an IVDO crashes after initiating a transaction with a corresponding IPDO, and the transaction requires IPDO to contact the IVDO that initiated the transaction, then there should be a mechanism by which the IVDO when restarted is identified by the IPDO that it is the same IVDO or its equivalent process that the IPDO need to use for completing the transaction. One approach to do this would be to uniquely identify the instantiated IVDO that belongs to a particular application and use this identifier to have the IPDO identify the IVDO. In other words, if an IPDO finds out that the handle it possesses for the IVDO that was supplied by the IVDO during the coupling phase has become stale (through an exception thrown by the distributed object subsystem), then it will contact a service (called the transaction support service) using the unique ID that the IVDO uses every time it is instantiated as part of a given application. On contacting the transaction support service, it will obtain the new contact information to get a handle to interact with the IVDO. The contact information for locating the transaction support service, the unique ID corresponding to the IVDO and the contact information of the IVDO are exchanged in the coupling sequence that happens between an IPDO and IVDO in the first contact.

The above scenario presupposes that the user will notice an IVDO belonging to the application crashing and restart the IVDO or the entire application before the IPDO needs to interact with the IVDO.

The exact same scenario may happen where the IPDO is the peer that crashes and the IVDO needs to use the same technique to resume the transaction that is unfinished.

2. Having a universal user identification address to inform the user to re-initiate an application to complete unfinished transactions.

When the user does not restart the application that has exited with unfinished transactions, the user may be informed on how the user can take action that will allow the user to initiate the application to complete the transaction. In order for either of the peers in a virtual service internet widget to be able to do this there needs to be a way to inform the user of suspended transactions using a channel other than the channel used by the two peers to communicate in normal course. E-mail that is a catch all place that users track for messages is a good mechanism to use by either the IVDO or IPDO to inform each other of unfinished transactions that need to be completed. E-mail addresses are exchanged as part of the coupling sequence.

3. Buffering unfinished transactions for a limited duration to allow interrupted processes to gracefully complete transactions despite unforeseen interruptions to the participating processes.

In order for applications and peers to resume suspended transactions, the transactional information has to be buffered appropriately. Considering high reliability requires transactions to complete despite applications involved in the transactions crashing, one needs to use persistent storage to buffer transactions to be finished on this storage to ensure that high degree of reliability is achieved. Whenever an application restarts (and hence IVDOs and IPDOs), it will have to attempt completion of suspended transactions by reconnecting with the appropriate peers. Besides the fact that on restart each IDO & IVDO has to check for unfinished transactions and attempt to complete these transactions, the semantics of individual transactions will be peculiar to the semantics of the IPDOs and IVDOs involved in the transaction.

Implementables:

1. Transaction support service

2. The coupling interfaces that exchange the contact information (transaction services, unique Ids, e-mail addresses etc) between an IPDO and an IVDO.

Additional Internet Widget Concepts:

What is the Need for Executing Internet Widgets as Separate Processes?

An important reason for making elements of internet widgets, such as the primary/model objects and the corresponding reflection objects as instantiable distributed objects (IDOs) instead of having multiple objects be instantiated as part of a single application is to be able to address the distributed objects from multiple applications that execute on different processors without too much programming complexity. Considering the primary/model objects execute on the primary plane of execution computers that are not necessarily the same set of computers used for executing the reflection objects belonging to the visualization plane of execution, it is necessary to address the same object from multiple applications.

To make internal objects addressable by external applications, an application will have to implement a lot of code. If the IDO is the object that is instantiated and is made addressable using the distributed object technologies prevalent today, then it simplifies the effort for creating the objects in IDOs as separate processes and not club multiple objects into single process. This has some security and performance ramifications that are addressed in sections below.

Linked Serialization & De-serialization:

As discussed earlier, it is possible to create IDOs and internet widgets using already implemented IDOs and internet widgets. If the persistent representations of the IDOs and internet widgets are saved in a filesystem as serialized objects, derived objects that store their persistent representations in turn contain other objects. Serialization that involves IDOs and internet widgets use a slightly altered semantics for serialization as the contained objects can be outside the process boundaries.

For purposes of illustration, objects (IDOs) A and B are used in the implementation of object (IDO) C. From the semantics of the IDO instantiation it has been established that an IDO should be able to use the persistent representation of the object in the instantiation of the object. In order for this to work for object C, object C should be instantiable using a persistent representation of object C. But object C is implemented using objects A and B, which are in turn themselves instantiable. In order for C to be completely instantiable, there are two ways in which the persistent data of C can be stored.

1. One of the two ways is to store the data that is specific to the object C on the persistent storage and also as part of the persistent storage of C store the data that is necessary to instantiate A and B. In order for this to work, the location in object C that stores the data relevant to objects A and B should obtain this data from these objects every time the object C has to be committed to the persistent storage. This need to store A & B object data as member data of the containing object C is due to the fact that instantiating of A & B by C requires either a path name to a file containing the persistent objects of A & B or the equivalent data to be handed to the instantiating sub-system. This is a little different for the IDOs that comprise internet widgets as opposed to regular objects that are members of other objects where the normal serialization/de-serialization semantics would be sufficient to restore the values of the objects and their internal members as instantiated. In IDOs de-serialization there is an extra step of instantiation that has to happen using the values needed for instantiation.

2. The alternative way to solve this problem would be to commit objects A and B to the persistent storage at some location on the persistent storage, and have a link or a reference to the location of these objects as the member elements of the object C. The objects A & B also have access to the name of this location in order for them to commit themselves to the specified location when recursive serialization sequence is initiated by an object in a higher level in the containment hierarchy. This type of serialization is referred to as “Linked Serialization”.

The second alternative is a preferred alternative for numerous reasons, besides the fact that the data of member objects need not be duplicated in the containing object in a recursive manner. Another significant advantage is the fact that applications that want to operate on member elements of an object can do so without having to de-serialize a containing object.

There are two ways in which the member objects A & B can be made part of an object C.

1. Have a find and assign step in the initial creation of the object C, where object C searches some directory hierarchy to identify persistently stored objects of type A and B in some file storage (directory hierarchy or a database) and asks the user to explicitly assign the specific objects that should be members of object C. The object C also may provide a means for users to alter the locations that it points to for the objects of type A and B after the initial assignment.

2. Object C creates a named location and uses the instantiation infrastructure to create the objects A and B without any prior persistent storage versions of these objects. The objects A and B will serialize themselves to these locations on the first serialization sequence started by a containing object. The algorithm that helps object C come up with names and locations of A and B will try to preserve the containment connotation by perhaps creating a directory in the current location where the location for storage of the object C, and come up with a new name that does not collide with any existing names.

The Containment Hierarchy of Serialized Objects:

In Linked serialization, the containment hierarchy of the primary/model objects is preserved with the serialized persistent representation of the objects that are used in layered object oriented programming. For storing the persistent representation of an object for the very first time (if the application is not loaded from an existing persistent representation of an application) the application needs to be pointed to a location in the storage space for the top level object, and the rest of the contained objects will be saved as predicated by the containment hierarchy.

Dual-format-serialization:

In order to be able to allow an object that is serialized to a persistent storage to be used by several applications, a technique called dual-serialization may be used. The way multiple similar applications can interchangeably use the data created and modified by them is by adhering to some open standard representation of the data. In the industry some of the commonly used open standard for representing objects of various types are things like JPEG, MPEG etc. It is also true that the process of standardization is usually laborious and improving the standards takes longer than the needs of application developers to enhance the functionality that is representable in a standard format. Invariably an enhancement of the data format with an extension to benefit a particular application will make the data less usable for other applications. In order to facilitate an approach that makes it possible for applications to improve on the data format without making the represented useless for other applications while the enhancement is waiting to be blessed by the standards body, an approach is provided that retains the portability of the data without limiting the capability of enhancing the data format for new functionality.

It is possible for applications to preserve this dual capability by providing in the infrastructure for serialization a capacity for objects to serialize data into two files called the object format serialization and standard format serialization. The object format serialization of an object serializes the object as is so that the specific implementation of the object can de-serialize using this representation. The standard format serialization serializes the object in a well known standard format related to the specific object. The infrastructure will make it possible for an object and its objects contained in the containment hierarchy to be serialized in both forms of serialization, just one form if the user intends to do it that way. When it comes to de-serialization at object initialization, the infrastructure will provide the support to identify the serialized object in the standard format if an object with the name supplied by the instantiating object does not find the object serialized in the object serialization format. This capacity to serialize in the two formats and de-serialize from both formats is called “Dual format serialization”. By specification, all objects used in internet widgets need to be serialized in both formats to preserve the portability of the data across multiple implementations of the objects. Application developers that use objects that do not implement dual-serialization will make the data created by their applications less useful to users of their application.

Referential Integrity of Dual-serialization:

One of the important aspects of data integrity that makes conventional databases very valuable is the referential integrity of data. Simply defined, any dependent referring data that depends on other referred data should always reflect the changes made to the referred data. Since linked serialization shares the referring relationship between the child and parent objects that are serialized, the parent object should be able to maintain referential integrity if they chose. The implementation of the internet widget framework should accommodate this requirement. As to the default behavior, the implementers need to judiciously select the most desirable behavior as the default behavior.

Implementables:

Interfaces that are to be implemented by the primitive object that all IDOs are derived from to facilitate IDO serialization, linked serialization and dual-serialization.

Application Development Using Internet Widgets:

Creating applications using internet widgets involves using simple internet widgets or the virtual service internet widgets in software development. A more extensive treatment of this topic will be created in the programming manuals.

As internet widgets make it possible for the users of objects to display the visualization of objects without additional programming both for distributed service object and simple objects, the amount of code that needs to be written is substantially less. By using virtual service internet widgets of services made available by physical devices, integrating devices available on the local network is greatly simplified given the availability of UI associated with the particular device already implemented and usable.

Packaging the Application and the Installation of the Application:

A packaging strategy that will allow for multiple internet widgets that are used in the application to be installable, will ensure that name collisions are avoided in the packaging and linking phase of the application.

Implementable:

Packaging software that analyzes the source code of the application to locate the dependent internet widgets that need to be packaged. Every internet widget in its package keeps a file that enumerates the IDOClassImplementationDefaultLocationPathName used in the particular internet widget. Recursively iterating over the dependencies one can identify and package all the software modules that are needed in the packaging step.

Dynamic Switching of Objects/Internet Widgets Contained by an Internet Widget:

Internet widgets may some times want to switch the contained internet widgets that are used in an application during the execution of an application. For instance, a user may want to switch the printer that a user uses and hence will need to switch the IVDO to point to the new printer. In order to facilitate this, the containing internet widget/object has the responsibility to use a searching internet widget that can locate IVDOs of different physical devices and then substitute the IVDO used as part of the application. For this to be possible, every service internet widget may have an associated search and find internet widget that applications and containing internet widgets can use.

Implementable:

Infrastructure support for dynamic switching of IVDOs that will let applications switch IVDOs that implement the same interface but in a different way.

Execution of an Application Developed Using Internet Widgets:

Considering the instantiation of various internet widgets belonging to an application can happen on different hosts, both the locations that contain the persistent representation of various objects and the packaged location of various internet widgets that are used by the instantiating sub-system need to be accessible on all the hosts that execute the elements of internet widgets.

Security:

Using the internet widget infrastructure simplifies integrating of security related functionality such as strong authentication and authorization based on access control policy into applications very easily. Besides this advantage, there are several improvements in protecting data that are made feasible with the internet widget abstraction that are thoroughly exploited when internet widgets are used in synchronized computing.

Performance:

The design of individual internet widgets will influence the performance characteristics of internet widgets. Considering internet widgets can be scheduled on different cpus by a scheduler that can monitor the currently used cpus, it is possible to improve performance with a very good scheduler. There however is an additional latency price that comes about in converting in process objects into distributed objects. A judicious choice of the internet widgets appropriate for the task at hand will have a significant impact on the performance characteristics of the applications. Another variable in the performance of applications built using internet widgets is to compare the number of small applications that are executed on a multiple machines as opposed to a single monolithic application executing on one computer.

Latency of Accessing and Instantiating Remote Objects as Opposed to Local Objects:

As mentioned in the above section, one needs to implement the internet widgets that contain other internet widgets judiciously. If they can be implemented using local objects, then the software designers need to trade of the advantages and disadvantages in implementing some functionality using internet widgets as opposed to regular classes.

Consolidation of Internet Widgets:

It may be possible to consolidate the functionality that is implemented using multiple internet widgets into a single internet widget. The code-reuse proportion will diminish if the consolidation is preferred, however it would improve the performance characteristics of the functionality implemented as internet widgets.

Model Composed as Sub-models vs Model With a New Data Format:

When consolidation of internet widgets happens the model object or the object in primary plane of execution may use a different data format when the equivalent functionality is implemented using multiple internet widgets. In such circumstances, a well behaved internet widget will make it possible for the data to be saved in its constituent parts if desired by the user of the internet widget.

Subdivision of Model into Sub-models:

The subdivision of a model into sub-models by an internet widget is a useful way to allow applications that use sub-model data to access data that is inaccessible if the super model does not disaggregate the data.

Standard Interfaces:

Using standard interfaces as opposed to non-standard interfaces has varying implications on the way the objects can be used seamlessly in multiple applications. If an application is built using an object that implements an open standard interface, then the application can use another object that implements the same interface without any modifications to the application. In fact it will be possible for users of the application to indicate a preference to a particular implementation of an interface (editor for instance), and all applications that instantiate an object will prefer the user's choice if available thus making the usage of applications as user friendly as possible. On the other hand if the various editor objects implement different non-standard interfaces, then the application cannot easily switch between different implementations of interfaces with similar semantics by various objects.

One of the programming guidelines for the developers of internet widgets is to strictly adhere to existing interface definitions while implementing objects of a particular kind. This would greatly benefit both the users of the objects and the object creators. The users of the object can swap in the object of their choice in their applications if they have a preference, and the object creators can expect their objects to be usable by several applications that have already created applications with the expectation that the standard interface is implemented by the object. This in itself improves code-reusability to a great degree.

Implementable:

An enhancement to the IDO instantiator that selects user preferred classes for a particular type of a class implementing all the necessary interfaces.

Standard Data Formats:

In order to make data portable across multiple applications, data formats for any and every object should be available in an open standard data format of that particular object type. In order to ensure that data used by objects belonging to internet widgets are standard, dual-format-serialization is recommended. The dual-format-serialization provides a greater degree of portability of data across multiple applications that operate on similar data, while it also provides a way for the data-format to be extended in minor non-standard ways that will not affect the portable component of the data.

Partitioning of the Internet Widget Infrastructure Software:

Core Internet Widget Device Software Set:

Core internet widget device software is that software that runs on every computer that would execute any of the following internet widget software elements such as a primary or secondary objects of an internet widget or an IPDO in case of devices.

Core Internet Widget Network Software Set:

Core internet widget network software is that software that runs in a network of computing devices to facilitate the execution of internet widgets. These software elements need not run on each device but one or more instantiations should execute within the network in order for internet widget software to be functional. For example, the running of a global name service in the network prior to executing any devices is mandatory within the network. (The exact set of software that belongs to the core internet widget network software set is yet to be specified.)

V Advantages:

This section describes primary advantages of developing software using internet widgets, which in general, are solutions to the problems posited in the section that explores the rationale for internet widgets. Also described are other apparent advantages in developing software applications that use an internet widget as a software component primitive.

Primary Advantages:

In the section titled “The rationale for an internet widget”, it was identified that existing software component primitives that are used in creating distributed software services had the following shortcomings.

1. Re-implementing client functionality by each solution creator.

By definition internet widgets in all their forms have to provide the client functionality that can be programmatically usable for integration in any solution that solution creators create.

2. Substantial software development effort is needed for any server integration.

With internet widgets that approximate traditional servers, the programmable component of a virtual service internet widget for the different servers that may need to be integrated present the integrator with a software abstraction that is easily programmable. Hence it simplifies the integration effort. The virtual service internet widget that is implemented by server developer provides the UI client object of the visualization plane and a IVDO virtual object in the model plane that ensures the server through its IPDO is ensured of appropriate access when multiple clients attempt to use the services of server simultaneously. These are the additional tasks a server integrator needs to contend with in the absence of internet widgets.

3. Client implementation done by non-experts for a given server.

By the very definition of internet widgets, this advantage follows for developers that use internet widgets.

4. Lack of infrastructure support that enables clients to register callbacks with server applications.

Internet widgets in their specification partially address the support for this kind of usage. However for complete specification that addresses issues such as security the reader is referred to synchronized computing [SHAN00].

5. Difficulty in integrating client call backs for various servers of the services by client implementers that are different from the server implementers.

Here too, the definition of internet widget and the associated coupling techniques developed in this document solve this programming difficulty to the current service integrators.

6. Inability to plug different user interfaces.

As explained in the sub-section titled “Dynamic switching of objects/internet widgets contained by an internet widget”, it is possible to switch IDOs on the fly or have apps be configured to use a substitute internet widget at the initial invocation that implements the same programmatic interface to be integrated with the application but that has a different UI. The subsection on standardization deals with this problem too. This ability to substitute an internet widget or dynamically switch internet widgets makes it possible to easily change the user interface without altering the functionality of an application.

7. It requires non-trivial effort to extend controller functionality of a model in the MVC abstraction.

By extending an already implemented internet widget, as internet widgets are as extensible as ordinary objects, it is easy to add additional controller functionality to a model of the object. Such extended internet widgets if they do not alter the programming interfaces of the model object can very easily be substituted for the base internet widget in applications without recoding and compilation dynamically. The visual containment of layered object oriented programming with multiple planes of execution will ensure the addition of the new UI for the controller in the app that uses the extended internet widget. The UI of the extended internet widget including the UI of the controller and the UI of the base internet widget will be displayed together in the place of the UI for the base internet widget alone when an application picks up the extended internet widget. Thus the controller UI will be located adjacent to the UI of the internet widget that it belongs as stipulated by the designer of the UI for the extended internet widget.

8. Difficulty in binding various interfaces used by servers that are part of an application. As the client UI elements of internet widgets are instantiable distributed objects (IDOs), they are by design programmable. It is their use that allows the integration of various server interfaces to be bound to create a new server or in our case a new internet widget that now can be visualized and provides new integrated server functionality.

9. No structured way to launch an application that uses several servers that are not already launched at the time of client invocation.

The instantiable distributed object is instantiable by the clients and this makes it possible for clients to trigger the invocation of servers be they those that belong to simple internet widgets or the ones that belong to virtual service internet widgets that stimulate the invocation of a corresponding IPDO.

10. No structured way to encapsulate data that belongs to the application that uses multiple servers.

Linked serialization abstraction that was introduced by the internet widgets makes it possible for a structured way to define all the data that belongs to an application by the serialized internet widgets that are linked and stored.

Other Advantages:

Besides the obvious advantage of addressing the problems described to present the rationale for internet widgets, there are other benefits to using internet widgets as software component primitives in software development. They are:

Device-to-UI Components that can be Developed by the Experts of the Device and the Device Technology:

As was described in the description of internet widgets, the special class of internet widgets called the virtual service internet widgets can be developed by the manufacturers of networked devices. The virtual service internet widgets are comprised of software elements that connect the device hardware with the user interface functionality that lets users interact with the device, and it also includes the requisite support for multiple applications to simultaneously access the devices in a meaningful way.

Infinite Scalability by Using Internet Widgets that can be Instantiated on Any Machine:

Another significant benefit of using internet widgets in software development is the possibility of scheduling the various instantiable distributed objects on multiple computers and thus making it possible for spreading the computational power demands of an application on multiple machines.

Simplifies the Programming Abstraction for Using Distributed Object Oriented Programming Over Data-protocol Oriented Programming:

By defining a framework that will allow people to create applications that use the programmable event abstraction for synchronous and asynchronous exchanges between communicating peers, the internet widget framework is simpler to create applications with when compared to data-protocol oriented programming that requires interpreting the semantics of the data-protocol because the semantics are not encapsulated with the data unlike programmable distributed events.

Easier Integration of Devices With Applications:

One significant advantage of virtual service internet widgets developed for devices is that it is easier to develop the applications that use these devices. This is due to the availability of the visualization object that is integrated into the visualization execution plane of the application and the instantiable virtual distributed object (IVDO) integrated within the containment hierarchy chosen for the application. The same applies for creating applications that use multiple devices and for when devices need to communicate with each other.

Distributed Storage of App Data, and Sharing of Data by Multiple Apps:

The concept of linked serialization that is described in this document makes it possible for the apps built using internet widgets to span the serialized objects of the internet widget in different persistent storage locations. Linked serialization in conjunction with the dual format serialization makes it possible for multiple applications to use the same data even when the internet widgets that use the data do not necessarily access the data using the same internet widget applications.

Addresses the Standardization of Data Formats and Interfaces:

One of the common problems in software development is the problem of standardization. Most software development technologies attempt to provide some methodology that will help in the standardization of either data formats or the standardization of interfaces. In the absence of standardization of both of them simultaneously it will be difficult to re-use and substitute software modules that operate on the data saved by different implementations of the same semantics of a particular internet widget. With internet widgets the standardization problem has been addressed in its completeness. Also impeding the standardization of data formats and interfaces is the slowness of constituted organizations taking interminable amount of time to agree on the standard and the difficulty of people finding the standards when they need to build using existing standards. Internet widget infrastructure facilitates the expediting of standardization.

Internet widget abstraction is developed in this document. This abstraction provides a model for building more powerful re-usable distributed components. However, the full power of programming using internet widgets is unleashed when internet widgets are used as primitive programming software elements in synchronized computing.

IV References:

[BULG97] Bull CP8, Gemplus S A, Hewlett-Packard Company, IBM Corporation, Microsoft Corporation, Schlumberger S A, Siemens Nixdorf Informationssysteme A G, Sun Microsystems, Inc., Toshiba Corporation, VeriFone, Inc., “Interoperability Specification for ICCs and Personal Computer Systems, Part 1. Introduction and Architecture Overview Revision 1.0”, December 1997

[MICR95] Microsoft Corporation, “The Component Object Model Specification, Version 0.9”, Oct. 24, 1995.

[OMG97] Object Management Group, “The Common Object Request Broker: Architecture and Specification Version 2.1”, August 1997,

[SHAN00] Shankar Narayan, “Synchronized Computing with Internet Widgets”, Sep. 19, 2000

[SHAN00A] Shankar Narayan, “QAISR Architecture Using Internet Gidgets—A Qme Internet Gidget Version: 1.1”, Sep. 19, 2000

[STEV87] Steve Burbeck, “Applications Programming in Smalltalk-80: How to Use Model-View-Controller (MVC)”, Copyright 1987.

[SUN97] Sun Microsystems, “Java Beans™, Version 1.01”, Jul. 24, 1997.

[TIMF97] Tim Lindholm, Frank Yellin, “The Java™ Virtual Machine Specification, Second Edition”, Copyright 1997-1999

[VLAM99] Vlada Matena, Mark Hapner, “Enterprise JavaBeans™, Version 1.1, by Vlada Matena, Mark Hapner, Dec. 17, 1999.

[W3C98] W3C (World Wide Web Consortium), “DOM Level 1 Specification”, October 1998.

VII Hardware Terminology:

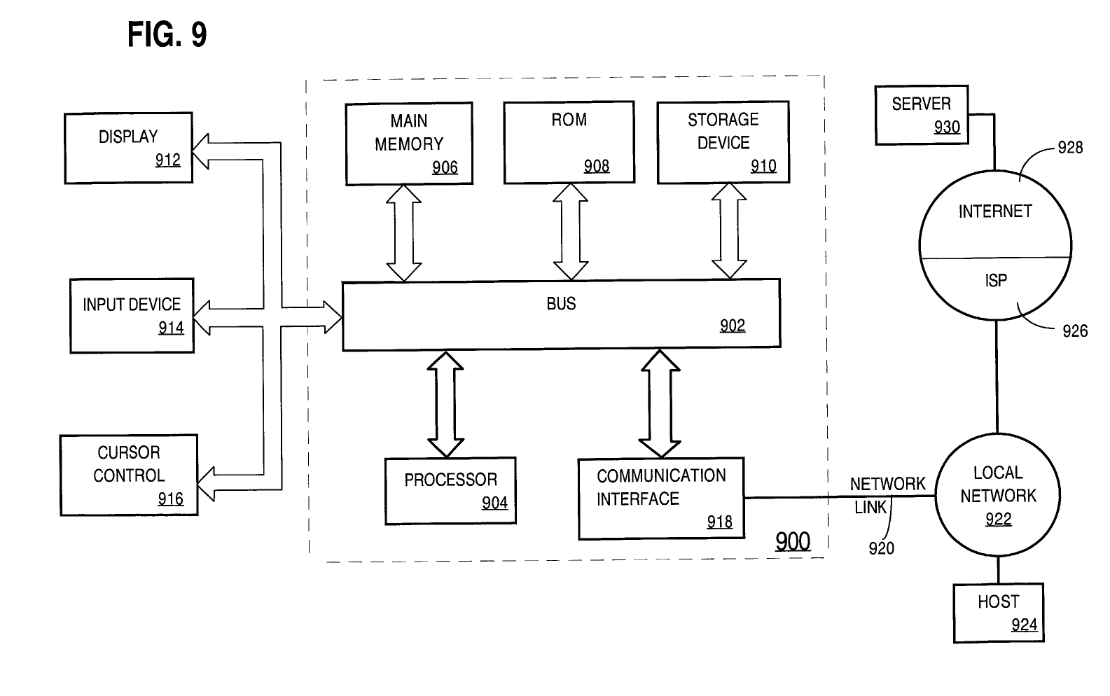

FIG. 9 is a block diagram that illustrates a computer system 900 upon which an embodiment of the invention may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for implementing the techniques described herein. According to one embodiment of the invention, those techniques are performed by computer system 900 in response to processor 904 executing one or more sequences of one or more instructions contained in main memory 906. Such instructions may be read into main memory 906 from another computer-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution. In this manner, computer system 900 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of managing objects in an object oriented environment, the method comprising the steps of:
generating a first set of objects that are related according to a first hierarchical relationship;
executing one or more methods of said first of set of objects to generate a second set of objects that are related according to a second hierarchical relationship that mirrors said first hierarchical relationship; and
wherein each object of said second set of objects corresponds to a corresponding object in said first set of objects and is related to objects in said second set in a manner that mirrors how said corresponding object in said first set is related to other objects in said first set.

2. The method of claim 1, wherein said first hierarchical relationship and said second hierarchical relationship are containment relationships.

3. The method of claim 2, wherein:
one or more containment relationships between objects in said first set are based on a containing object containing a contained object; and
the method further includes performing the step of, for each containment relationship of said one or more containment relationships, the containing object requesting creation of the respective contained object.

4. The method of claim 1, wherein each object in said second set of objects is created by executing a method of a corresponding object in the first set.

5. The method of claim 1, wherein each object of said first set and said second set are instantiable distributed objects.

6. The method of claim 2, wherein:
said first hierarchical relationship is associated with a first plurality of levels;
each level of said first plurality of levels is associated with at least one object from said first set;
no object in said first set is contained by another object in said first set that is at the same or a lower level of said first plurality of levels.

7. The method of claim 6, wherein:
said second hierarchical relationship is associated with a second plurality of levels;
wherein each level of said second plurality of levels is associated with at least one object from said second set; and
wherein no object in said second set is contained by another object in said second set that is at the same or a lower level of said second plurality of levels.

8. The method of claim 1, wherein any object in said first set with one or more ascendants defined by said first hierarchical relationship transmit messages to another object in said first set via said one or more ascendants.

9. The method of claim 1, wherein:
the first set includes a first object that contains a second object the second set includes a third object;
said first object corresponds to said third object;
the method further includes the steps of:
the first object invoking a method of the second object to cause said second object to create a fourth object that belongs to said second set;
the second object returning to said first object a reference value referencing said fourth object; and
said first object transmitting to said third object said reference value to establish a containment relationship between said third object and said fourth object.

10. The method of claim 1, wherein said second set of objects implement visual elements of a user interface.

11. A method of handling distributed objects, the method comprising the steps of:
a first client of a first object transmitting, over a network to a server, a request to instantiate said first object; and
in response to receiving said request:
instantiating said first object, and
causing said first object to be addressable over said network by at least one client other than said first client.

12. The method of claim 11, wherein the step of causing said first object to be addressable includes registering said first object with a name service.

13. The method of claim 11, wherein the steps further include generating only a single instance of said first object in response to attempts by other clients to create said first object.

14. The method of claim 11, wherein:
a set of one or more clients includes said first client; and
the steps further include each client in the set instantiating a first set of one or more objects through which said each client interacts with said first object.

15. The method of claim 14, wherein the set of one or more clients includes at least two clients.

16. The method of claim 14, wherein the steps further include, for each client of said set of one or more clients, creating a second set of objects that correspond to visual elements of a user interface for interacting with said first object.

17. The method of claim 11, wherein said request identifies a storage location for persistently storing said first object.

18. The method of claim 16, wherein the steps further include:
determining whether data for the first object is stored at said storage location; and
if data for the first object is stored at said storage location, using said data to initialize said first object.
